(19) United States
(12) Patent Application Publication
(10) Pub. No.: US 2026/0288819 A1
(43) Pub. Date: Sep. 24, 2026

(54) SYSTEM

(71) Applicant: SoftBank Group Corp., Tokyo (JP)

(72) Inventor: Shunichi TAMURA, Tokyo (JP)

(73) Assignee: SoftBank Group Corp., Tokyo (JP)

(21) Appl. No.: 19/567,488

(22) Filed: Mar. 16, 2026

(30) Foreign Application Priority Data
Mar. 19, 2025 (JP) 2025-045106

(51) Int. Cl. G06F 16/3329; G06F 40/30

(52) U.S. Cl. CPC G06F 16/33295; G06F 40/30

(57) ABSTRACT

A system includes a processor that is configured to generate a prompt that instructs a plurality of generative artificial intelligence models to execute a specific task in parallel, cause generated answers produced by the plurality of generative artificial intelligence models to be evaluated by other generative artificial intelligence models, select a final answer based on results of the evaluation, and analyze an emotional state of a user and provide an analysis result of the emotional state to at least one of the plurality of generative artificial intelligence models in order to optimize a dialogue with the user.

### CROSS-REFERENCE TO RELATED APPLICATION

This application is based on and claims priority under 35 USC 119 from Japanese Patent Application No. 2025-045106 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional dialog systems utilizing a single generative artificial intelligence model often suffer from limitations in answer reliability, consistency, and adaptability to the user's emotional state. In particular, when a single model is solely responsible for generating answers, the system may produce responses that are factually inaccurate, logically inconsistent, or unclear, and there is no internal mechanism for cross-checking or self-correction using independent models. Furthermore, many existing systems do not sufficiently consider the emotional state of the user, resulting in answers that may be technically correct but emotionally inappropriate, insensitive, or poorly aligned with the user's current psychological condition. As a consequence, user satisfaction, trust, and engagement can be significantly reduced. Therefore, there is a need for a system capable of: (i) leveraging a plurality of generative artificial intelligence models running in parallel, (ii) evaluating answers generated by these models using other models, and (iii) analyzing and incorporating the user's emotional state to optimize the dialogue in terms of both informational quality and emotional suitability.

### SUMMARY

In order to solve the above-mentioned problems, an embodiment of the present invention provides a system comprising a processor, wherein the processor is configured to generate a prompt that instructs a plurality of generative artificial intelligence models to execute a specific task in parallel. The processor is further configured to cause generated answers produced by the plurality of generative artificial intelligence models to be evaluated by other generative artificial intelligence models and to select a final answer based on results of the evaluation. In addition, the processor is configured to analyze an emotional state of a user and to provide an analysis result of the emotional state to at least one of the plurality of generative artificial intelligence models in order to optimize a dialogue with the user. In one aspect, the processor is configured to cause an evaluation of an answer generated by one of the plurality of generative artificial intelligence models to be performed by comparing the answer with at least one other answer generated by another one of the plurality of generative artificial intelligence models, and further to cause the evaluation to be performed in consideration of the emotional state of the user. In another aspect, the processor is configured to select, as the final answer, an answer having a highest evaluation score among the generated answers based on the results of the evaluation, and further to provide information that is most suitable for the emotional state of the user. By these means, the system improves the reliability, clarity, and emotional appropriateness of dialog responses through cooperative generation, cross-evaluation, and emotion-aware selection of answers.

The term “system” refers to a combination of hardware and software components, including at least one processor and one or more memory or storage elements, configured to execute the functions described in the claims.

The term “processor” refers to any hardware component or combination of components, such as a central processing unit (CPU), graphics processing unit (GPU), digital signal processor (DSP), application-specific integrated circuit (ASIC), or programmable logic device, capable of executing instructions to perform the operations described in the claims.

The term “prompt” refers to data including natural language text, structured instructions, or control parameters that instruct a generative artificial intelligence model to perform a specific task, such as generating an answer to a user's question.

The term “generative artificial intelligence model” refers to a machine learning model, such as a neural network trained on text, audio, image, or other data, that is capable of generating new content, including natural language responses, based on given input data or prompts.

The term “plurality of generative artificial intelligence models” refers to two or more generative artificial intelligence models that are logically or physically distinct from each other, and that can operate in parallel or independently to generate and evaluate answers.

The term “execute a specific task in parallel” refers to causing two or more generative artificial intelligence models to perform processing related to the same task, such as answer generation, during at least overlapping time periods, so that multiple answers are produced for the same input.

The term “generated answer” refers to a response, such as a natural language text output, that is produced by a generative artificial intelligence model in accordance with a prompt or user input.

The term “evaluate” refers to processing that analyzes an answer according to one or more criteria, such as validity, consistency, clarity, completeness, relevance, or emotional appropriateness, and that outputs an evaluation result, which may include a score, ranking, or qualitative judgment.

The term “evaluation result” refers to data representing the outcome of an evaluation of a generated answer, including at least one of a numerical score, a set of scores for respective criteria, a ranking relative to other answers, or categorical assessment information.

The term “final answer” refers to one answer selected by the system from among a plurality of generated answers, based at least on evaluation results, and provided by the system to a user as an output response.

The term “emotional state of a user” refers to a psychological or affective condition of the user, such as happiness, sadness, anger, anxiety, calmness, or stress, which can be inferred from user inputs, behavior, biometric data, or contextual information.

The term “analyze an emotional state of a user” refers to processing that estimates, classifies, or quantifies the user's emotional condition using one or more methods, such as natural language processing on user utterances, detection of acoustic features in speech, analysis of facial expressions, or evaluation of physiological signals.

The term “analysis result of the emotional state” refers to data representing the outcome of the analysis of the user's emotional state, such as an emotional category, a probability distribution over emotional categories, intensity levels, or other emotional metrics.

The term “optimize a dialogue with the user” refers to adjusting at least one of the content, tone, style, level of detail, or timing of system responses in order to improve user satisfaction, understanding, trust, or comfort, based at least in part on the user's emotional state.

The term “consideration of the emotional state of the user” refers to using the analysis result of the user's emotional state as a factor in at least one of evaluating generated answers, selecting a final answer, or generating additional prompts or responses.

The term “evaluation score” refers to a numerical value or set of numerical values assigned to a generated answer during evaluation, representing the quality of the answer according to one or more criteria, such as validity, consistency, clarity, or emotional appropriateness.

The term “information that is most suitable for the emotional state of the user” refers to content whose type, expression, tone, or level of detail has been selected or adjusted so that it corresponds to, supports, or appropriately addresses the user's current emotional state, as indicated by the analysis result.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

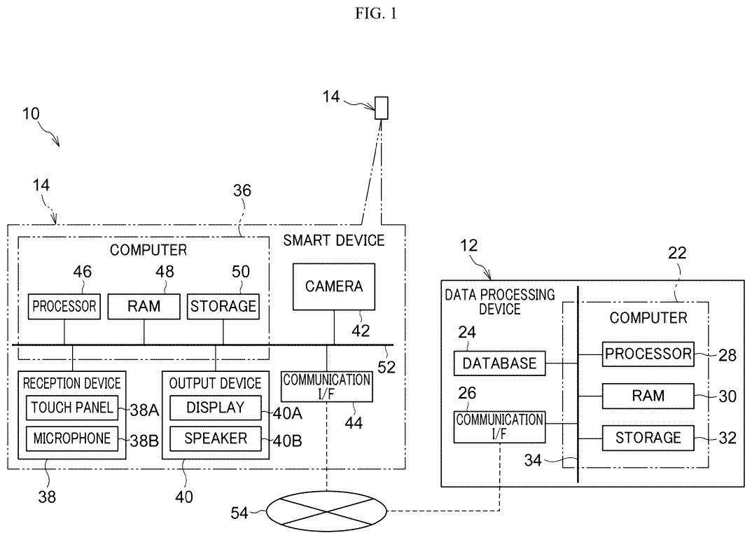

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

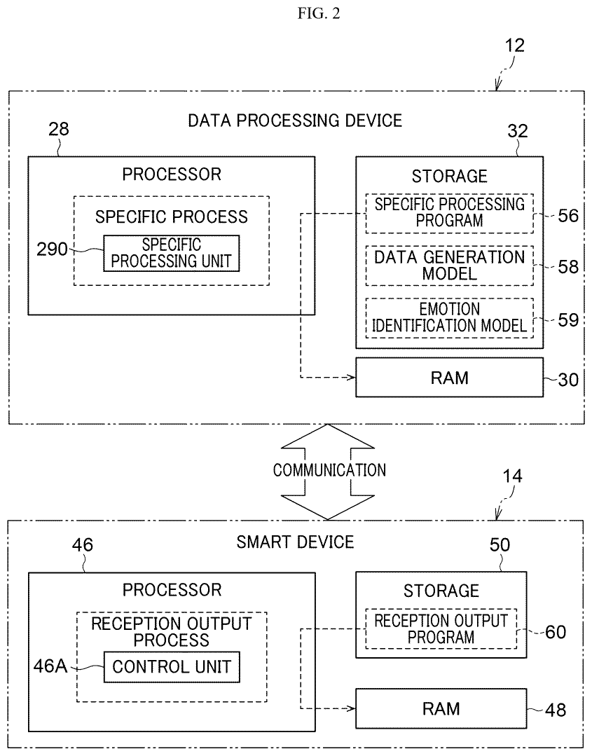

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional information processing systems that utilize a single generative AI model, the system typically produces only one answer for a given prompt sentence. Such systems suffer from several technical limitations. First, because only one model and one inference path are used, the system cannot effectively exploit model diversity, and thus cannot generate multiple answer candidates with different expression styles, knowledge focuses, or levels of detail. As a result, the system is prone to producing answers that are sub-optimal in correctness, clarity, or usefulness for different users and different usage contexts.

Second, known systems generally lack an integrated mechanism on the server side to orchestrate parallel execution of multiple generative AI models for a common prompt sentence, to evaluate their respective answer information in a structured manner, and to select or synthesize a final answer information item based on explicit evaluation criteria. This leads to inefficient use of computing resources, increased latency when multiple separate queries must be issued manually, and non-deterministic quality of the answers from the perspective of overall system performance.

Third, typical dialog systems do not systematically incorporate user emotion analysis information and user feedback information into the core answer selection pipeline running on a processor. While some systems may log user reactions or perform heuristic personalization on a client side, they do not tightly couple emotion analysis signals with model-level evaluation and selection logic in a feedback loop that improves subsequent inferences. Consequently, the system cannot dynamically adapt model operation conditions, such as model selection, weighting in evaluation, or parameter settings, to optimize interaction quality for users with different emotional states.

Fourth, conventional architectures do not provide a standardized server-side mechanism to associate a plurality of types of answer information with evaluation information, to transmit these to a terminal in a form that enables comparative display and structured user selection, and to capture such selection as machine-usable feedback. This results in fragmented data flows, makes it difficult to systematically collect high-quality supervision signals for model improvement, and limits the ability of the system to perform continuous, data-driven refinement of the generative AI models and evaluation algorithms.

Accordingly, there is a need for an improved computer-implemented system that can: (i) orchestrate parallel execution of multiple generative AI models on a shared prompt sentence; (ii) evaluate and compare a plurality of types of answer information using a dedicated evaluation process; (iii) integrate user emotion analysis information and user feedback information directly into the evaluation and selection pipeline; and (iv) update operation conditions of generative AI models and evaluation algorithms based on these signals. Such a system would improve the technical operation of server-side AI inference infrastructure by reducing the likelihood of low-quality answers, enabling more efficient use of computational resources, and increasing the robustness and adaptability of the interaction between users and generative AI models.

The specific processing by the specific processing unit 290 of the data processing device 12 in Example 1 is realized by the following means.

The present invention provides a server comprising a processor configured to receive, from a terminal, a prompt sentence including an inquiry input by a user via the terminal, and assign the prompt sentence as common input data to a plurality of generative AI models; to execute parallel operation of the plurality of generative AI models and cause the plurality of generative AI models, based on mutually different training data or mutually different parameter settings, to generate a plurality of types of answer information in response to the prompt sentence; to evaluate the plurality of types of answer information by using a separate generative AI model or an evaluation algorithm and calculate evaluation information regarding at least correctness, clarity, and usefulness to the user; to select, based on the evaluation information, at least one piece of final answer information from among the plurality of types of answer information, or integrate the plurality of types of answer information to generate integrated answer information; to transmit, to the terminal, the final answer information or the integrated answer information in association with the plurality of types of answer information, and enable the terminal to display the plurality of types of answer information in a comparable manner and to acquire feedback information based on a selection operation by the user; and to store emotion analysis information indicating an emotional state of the user, the emotion analysis information being transmitted from the terminal, and the feedback information, and update operation conditions of at least one of the plurality of generative AI models or the evaluation algorithm based on the emotion analysis information and the feedback information. This enables the server-side computer system to technically improve generation, evaluation, and selection of answer information by coordinating multiple generative AI models in parallel, by systematically incorporating user emotion analysis and explicit user feedback into the evaluation loop, and by adaptively updating model operation conditions to provide answers that are more accurate, clearer, and better matched to the user's emotional state, while efficiently utilizing computational resources.

The term “server” refers to an information processing apparatus including at least one processor and a memory, configured to communicate with one or more terminals over a communication network and to execute programs for managing generative AI models, processing prompt sentences, and generating, evaluating, and selecting answer information.

The term “processor” refers to one or more hardware computation units, such as a central processing unit or a graphics processing unit, capable of executing machine-readable instructions to perform operations including model inference, data evaluation, data selection, and communication control.

The term “terminal” refers to an electronic device operated by a user, such as a client computer, a mobile device, or another user interface device, which transmits prompt sentences and emotion analysis information to the server and receives and displays answer information from the server.

The term “user” refers to a human operator who inputs an inquiry or other information into the terminal, views answer information presented by the terminal, and performs selection or feedback operations with respect to the presented information.

The term “prompt sentence” refers to input data including at least one natural language expression representing an inquiry or instruction from the user, which is supplied to one or more generative AI models as a basis for generating answer information.

The term “generative AI model” refers to a machine learning model, such as a neural network model, that generates natural language or other output data in response to input data including a prompt sentence, based on training performed using training data.

The term “training data” refers to one or more collections of data, such as text corpora or dialog logs, used to train or fine-tune a generative AI model so as to determine parameters of the model.

The term “parameter setting” refers to a set of values, including model weights, hyperparameters, and inference configuration parameters, that define a behavior of a generative AI model during training or inference.

The term “answer information” refers to output data generated by a generative AI model in response to a prompt sentence, the output data including at least one natural language expression that attempts to respond to the inquiry contained in the prompt sentence.

The term “plurality of types of answer information” refers to two or more pieces of answer information generated for a common prompt sentence, the answer information differing from one another in at least one aspect such as style, level of detail, knowledge focus, or generation source model.

The term “evaluation algorithm” refers to a software-implemented procedure or model, distinct from the generative AI models that generated the answer information, configured to calculate evaluation information for the answer information based on predetermined criteria such as correctness, clarity, and usefulness.

The term “evaluation information” refers to data representing an assessment result for answer information, including at least one metric such as a score, rank, or label that quantifies correctness, clarity, usefulness, or other quality aspects of the answer information.

The term “final answer information” refers to one or more pieces of answer information selected by the processor from among the plurality of types of answer information based on evaluation information, for presentation with priority to the user.

The term “integrated answer information” refers to answer information generated by combining or synthesizing a plurality of types of answer information, the integrated answer information being formed by taking into account at least part of the content of the plurality of types of answer information and evaluation information associated therewith.

The term “emotion analysis information” refers to data indicating an estimated emotional state of the user, obtained by analyzing user-related signals such as text, voice, facial expression, or interaction behavior, and transmitted from the terminal to the server.

The term “emotional state” refers to a condition of user affect, such as satisfaction, frustration, curiosity, confusion, or calmness, inferred by an emotion analysis process and represented in the emotion analysis information.

The term “feedback information” refers to data indicating a user reaction or preference with respect to one or more pieces of answer information, the data being derived from operations such as a selection operation, rating operation, or explicit feedback input performed by the user on the terminal.

The term “selection operation” refers to a user operation performed via the terminal, such as clicking, tapping, or otherwise designating one or more pieces of answer information, to indicate a choice, preference, or evaluation among the displayed answer information.

The term “operation conditions” refers to settings or control parameters used by the server to manage execution of generative AI models and evaluation algorithms, including but not limited to model selection, weighting in evaluations, inference parameters, and scheduling policies, which can be updated based on emotion analysis information and feedback information.

The term “comparable manner” refers to a display format on the terminal in which a plurality of types of answer information are presented such that the user can visually or otherwise perceive differences between the pieces of answer information, for example by concurrently or sequentially showing them in a layout that facilitates comparison.

In one embodiment, the server includes at least one processor, a main memory, a non-volatile storage device, and a network interface. The processor is, for example, a central processing unit and optionally a graphics processing unit or tensor processing unit. The memory is, for example, a semiconductor memory such as dynamic random-access memory. The storage device is, for example, a solid-state drive storing program modules, configuration data, and model parameters. The network interface is, for example, an Ethernet interface or a wireless communication interface enabling communication with the terminal over a communication network.

The server stores, in the storage device, a program that, when executed by the processor, causes the server to perform management of a plurality of generative AI models, reception and transmission of a prompt sentence and answer information, execution of evaluation processing, and updating of operation conditions. The server uses an operating system, for example a general-purpose server operating system, and an application framework, for example a web application framework, to implement an application programming interface for exchanging data with the terminal. The server further uses a model execution framework, for example a deep learning framework, to perform numerical computation for inference and training of a neural network-based generative AI model.

The terminal includes at least one processor, a memory, a display device, an input device, and a communication module. The display device is, for example, a liquid crystal display or an organic light emitting diode display. The input device is, for example, a touch panel integrated with the display, a keyboard, or a pointing device. The communication module is configured to communicate with the server via a wireless or wired communication network. The terminal executes a client application that provides a user interface for inputting a prompt sentence, viewing a plurality of types of answer information, and performing a selection operation or other feedback operation.

The user operates the terminal to input the prompt sentence. The terminal presents, on the display device, a text input area and optional example prompt sentences such as “What is a black hole?”, “Please explain quantum entanglement in simple terms.”, “Please explain black holes in a literary style.”, “Please give a scientific explanation of black holes, including key physical concepts.”, and “Please explain what a black hole is in everyday conversational language, so that a junior-high-school student can understand.” The user enters one of these prompt sentences or another arbitrary prompt sentence and instructs the terminal to transmit the prompt sentence to the server.

The server receives the prompt sentence from the terminal and internally represents the prompt sentence as a character string with a defined character encoding. The server assigns the prompt sentence as common input data to a plurality of generative AI models. Each generative AI model is implemented as a neural network with a transformer architecture including an embedding layer, a plurality of self-attention layers, and an output projection layer. The server stores for each generative AI model a distinct set of parameters. For example, one generative AI model is trained on text data emphasizing literary works, another generative AI model is trained on technical and scientific documents, and another generative AI model is trained on conversational dialog data.

The server uses a tokenizer, for example a subword tokenizer based on byte pair encoding or a similar algorithm, to convert the prompt sentence into a sequence of token identifiers. The server performs this tokenization such that the same tokenization scheme is applied consistently to the input for the respective generative AI models. The server then supplies the sequence of token identifiers as input to each generative AI model. The processor performs matrix multiplication, nonlinear activation, layer normalization, and attention score computation according to the transformer architecture for each generative AI model. The transformer architecture uses query, key, and value vectors for each attention head and calculates attention weights via a scaled dot-product followed by a softmax function. By executing these operations in parallel across multiple generative AI models on the processor and, where present, the graphics processing unit, the server reduces overall latency for generating a plurality of types of answer information.

The server configures each generative AI model with different operation conditions such as maximum output length, temperature, and top-k or top-p sampling parameters to induce different styles and focuses of generated text. The processor, executing the generative AI models, outputs a probability distribution over vocabulary tokens at each time step and deterministically or stochastically selects output tokens according to the configured sampling method. The server decodes the sequence of output token identifiers into natural language text and thereby obtains multiple types of answer information corresponding to the same prompt sentence.

The server stores each piece of answer information in a structured data record in memory, together with metadata such as the identity of the generative AI model that produced it, the model configuration parameters, and timestamps. The server subsequently evaluates the plurality of types of answer information by using either a separate generative AI model or a non-neural evaluation algorithm. In one embodiment, the server uses an evaluator generative AI model that also has a transformer architecture, but is trained on pairs of question and answer data annotated with evaluation labels. The evaluator generative AI model receives as input a composed text that includes the prompt sentence and one or more pieces of answer information and outputs an evaluation score vector including at least correctness, clarity, and usefulness to the user.

In another embodiment, the server uses a non-neural evaluation algorithm that computes explicit feature values such as overlap of key terms with a set of reference terms, readability indices, and length constraints, and then calculates an evaluation score using a weighted sum of the feature values. The server may combine outputs of the evaluator generative AI model and the non-neural evaluation algorithm to obtain robust evaluation information. In each case, the server stores evaluation information in association with the corresponding answer information in memory.

The server uses the evaluation information to select final answer information or to generate integrated answer information. For selection, the server compares evaluation scores and extracts, as candidate answer information, at least one piece of answer information having an evaluation score that satisfies a predetermined condition. For integration, the server constructs an input text that includes the prompt sentence and the plurality of types of answer information, and supplies the input text to a synthesis generative AI model. The synthesis generative AI model, implemented as a transformer with encoder-decoder structure or a decoder-only structure, generates integrated answer information by attending over the content of the various answer information and producing a balanced output that reconciles technical correctness, clarity, and style. This non-conventional use of a generative AI model to perform controlled integration, rather than simple generation, yields reduced content redundancy and improved coherence compared with naïve concatenation or rule-based merging.

The terminal receives, from the server, the final answer information or the integrated answer information and the plurality of types of answer information. The terminal displays, on the display device, the plurality of types of answer information in a comparable manner, for example by arranging each piece of answer information in a separate display area labeled with the associated style or model type, such as “Literary”, “Scientific”, or “Conversational”. The terminal highlights the final answer information or the integrated answer information, for example by displaying it at the top of the screen or using a distinct visual cue. The user reviews the displayed information and performs a selection operation, such as tapping a preferred piece of answer information or providing a rating.

The terminal records the selection operation or rating as feedback information and may also obtain emotion analysis information. For example, the terminal executes an emotion analysis module that analyzes the user's input text or other interaction behaviors and estimates an emotional state, such as “satisfied”, “confused”, or “frustrated”. The terminal sends the feedback information and the emotion analysis information to the server.

The server receives and stores the feedback information and emotion analysis information in association with the corresponding prompt sentence and answer information. The server uses these stored data to update operation conditions of the generative AI models and the evaluation algorithm. In one embodiment, the server adjusts weight parameters used in aggregating evaluation scores. For example, when emotion analysis information indicates frequent confusion and feedback information shows that a particular generative AI model's answer information is often preferred, the server increases a weight associated with clarity or usefulness in the evaluation, or increases a selection priority of that generative AI model for similar prompt sentences.

In another embodiment, the server performs additional training of one or more generative AI models using feedback information as supervision. The server uses a loss function such as a cross-entropy loss or a pairwise ranking loss, in which answer information designated as preferred by the user is treated as a positive example and answer information not selected by the user is treated as a negative example. The processor executes backpropagation to compute gradients with respect to the model parameters and applies an optimization algorithm such as stochastic gradient descent or Adam to update the parameters. The server may also perform data augmentation, for example by generating paraphrases of prompt sentences or by synthetically perturbing answer information, to improve model robustness. By incorporating emotion analysis information as an additional feature or conditioning signal, the server can train models to adapt output style to user emotional state, thereby reducing the probability of producing answers that exacerbate negative emotional states.

The server uses explicit data structures and control flows to realize these functions. For example, the server maintains a model registry data structure storing identifiers for each generative AI model, its training data descriptor, and its operational parameters. The server maintains an answer record structure that includes fields for prompt sentence, model identifier, answer text, evaluation information, and feedback information. The server executes scheduling logic that dispatches inference jobs for multiple generative AI models to available processing units in parallel, taking into account current load and latency constraints. This structured control of hardware resources improves computational efficiency compared with sequential or ad hoc invocation of models.

By coordinating multiple generative AI models on the server side, the system achieves technical improvements in several respects. First, the parallel generation of different types of answer information on a shared prompt sentence reduces total response time compared with a sequential approach, thereby improving processing speed. The server pipelines tokenization, transformer inference, and decoding operations across models and processing units, reducing idle times of the processor and graphics processing unit. Second, the use of explicit evaluation information and integration logic reduces variance in answer quality and increases overall accuracy and clarity, because the system does not rely on a single model's output, but instead uses cross-model comparison and an evaluator that has been trained or configured to detect deficiencies such as omissions or contradictions. Third, the feedback loop using emotion analysis information and feedback information enables continuous adaptation of operation conditions, which leads to lower error rates and improved alignment of answers with user needs over time. This feedback-driven parameter update mechanism is fundamentally different from manual tuning or static configuration and constitutes an improvement to the functioning of the computer system as a whole.

The server and the terminal thus cooperate to implement a concrete data flow and processing architecture that is more than an abstract idea of “asking multiple models and choosing the best”. The server accesses and controls physical computation resources, such as processors and memories, according to a defined parallel execution and evaluation strategy. The terminal performs specific display and input control logic to present multiple answer information items in a comparable manner and to capture structured feedback information. By operating under these rules, the system reduces communication load between server and terminal (for example by sending consolidated evaluation and integrated answer information instead of requiring multiple round trips for each model), reduces redundant computations (for example by reusing tokenized representations across models where possible), and improves data management (for example by storing prompt sentences, answer information, and associated metadata in a normalized format suitable for training and monitoring).

In alternative embodiments, the server may vary the type and number of generative AI models, the structure of the evaluation algorithm, and the degree of integration of emotion analysis information. For example, the server may use an encoder-decoder transformer for one generative AI model and a decoder-only transformer for another generative AI model, or may partition the models across multiple physical servers to balance load. The server may also use different loss functions, such as hinge loss or listwise ranking loss, during training for certain domains. In another variation, the terminal may conduct part of the emotion analysis processing locally using a lighter-weight neural network model and transmit only compact emotion analysis information to the server, thereby reducing bandwidth usage and processing load on the server.

In each embodiment, the server, the terminal, and the user interact through a concrete sequence of hardware-implemented operations. The system therefore provides a specific improvement in computer technology by enhancing the way in which multiple generative AI models are orchestrated, evaluated, and adapted in response to user interactions and emotional states, rather than merely automating human judgment.

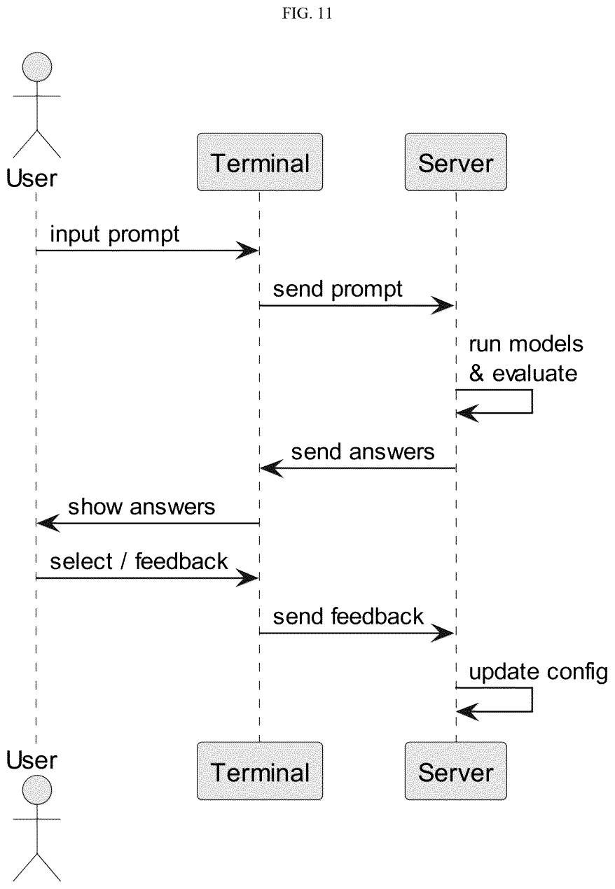

The following describes the processing flow using FIG. 11.

### Step 1

The user operates the terminal to input a prompt sentence. The terminal displays a text input area and optional example sentences such as “What is a black hole?” or “Please explain quantum entanglement in simple terms.” The input of this step is user keystrokes or touch input, and the output is a completed character string stored in a buffer inside the terminal. The terminal converts the sequence of key events into a Unicode text string and associates it with a session identifier for later transmission.

### Step 2

The terminal transmits the prompt sentence to the server. The input of this step is the character string produced in Step 1, and the output is an application-layer message delivered to the server via a communication network. The terminal packages the prompt sentence and metadata (for example, language code and user or session ID) into a request structure, encodes it as a text payload, and sends it through a communication module using a network protocol stack.

### Step 3

The server receives the prompt sentence from the terminal. The input of this step is the network-level message carrying the prompt sentence, and the output is an internal representation of the prompt sentence stored in server memory. The server's network interface assembles packets into a complete message, and a server-side application parses the message to extract the prompt sentence, converts it into a normalized character encoding, and stores it in a data structure together with a timestamp and a request ID.

### Step 4

The server assigns the prompt sentence as common input to a plurality of generative AI models. The input of this step is the normalized prompt sentence text and configuration data indicating which models are active, and the output is a set of model input descriptors ready for inference. The server creates, for each generative AI model, an entry that pairs the prompt sentence with model-specific parameters such as maximum output length and sampling configuration, and stores these entries in a job queue or task scheduler.

### Step 5

The server tokenizes the prompt sentence for each generative AI model. The input of this step is the prompt sentence text and the tokenizer configuration for each model, and the output is a sequence of token identifiers for each model. The server applies a subword tokenization algorithm, such as byte pair encoding, to map the string of characters to indices in the model vocabulary, generating integer sequences. The server may reuse a single token sequence across models when they share a vocabulary, thereby avoiding duplicate computation and reducing processing time.

### Step 6

The server executes parallel inference of the plurality of generative AI models using the tokenized prompt sentence. The input of this step is the token sequences and the stored model parameters for each generative AI model, and the output is a set of output token sequences representing answer information from each model. The server dispatches inference jobs to processing units, such as a central processing unit and a graphics processing unit, and performs transformer network computations including matrix multiplications, attention weight calculations, non-linear activation, and layer normalization. The server performs these operations concurrently for different models by using multiple threads, asynchronous tasks, or process pools.

### Step 7

The server decodes the output token sequences from each generative AI model into human-readable answer information. The input of this step is the token identifier sequences produced in Step 6, and the output is a plurality of natural language texts corresponding to different types of answer information. The server maps token identifiers back to subword units using a vocabulary table, concatenates the subwords, and reconstructs complete sentences. The server stores each answer text together with the identity of the generating model and associated inference parameters in an answer record.

### Step 8

The server evaluates the plurality of types of answer information using an evaluation process. The input of this step is the prompt sentence and the set of answer texts, and the output is evaluation information including quality scores and possibly explanatory comments. The server either supplies the prompt sentence and answer texts to an evaluator generative AI model, which computes scores by processing an input sequence containing markers for question and answer segments, or applies a deterministic evaluation algorithm that calculates features such as keyword coverage, length, and readability. The server aggregates these score components into a structured evaluation record for each answer.

### Step 9

The server selects final answer information or prepares data for answer integration based on the evaluation information. The input of this step is the set of evaluation records and the corresponding answer records, and the output is either a selection of one or more answer records or a composite input specification for a synthesis model. The server compares evaluation scores for criteria such as correctness and clarity, applies threshold conditions, and chooses candidate answers that satisfy these conditions. The server then either designates one candidate as final answer information or constructs an integrated text containing the prompt sentence and the candidate answers for further processing.

### Step 10:

The server optionally generates integrated answer information using a synthesis generative AI model. The input of this step is the composed input text containing the prompt sentence and multiple candidate answers, and the output is a single integrated answer text. The server tokenizes the composed text, feeds it to a transformer-based synthesis model that computes attention across all answer segments, and generates a new sequence of tokens. The server decodes the tokens to produce integrated answer information that merges technical accuracy, clarity, and style of the underlying answers.

### Step 11

The server packages the final answer information or the integrated answer information together with the plurality of types of answer information for transmission to the terminal. The input of this step is the final or integrated answer text and the individual answer texts, and the output is a structured response message. The server constructs a response format containing fields for the prompt sentence, each answer text, identifiers indicating model type or style, evaluation scores, and an indication of which answer is final or integrated. The server serializes this structure into a text-based payload and sends it via the network interface.

### Step 12

The terminal receives the response from the server and prepares display data. The input of this step is the structured response message delivered over the network, and the output is a set of user interface elements representing the different answer texts. The terminal parses the message, extracts the prompt sentence, answer texts, and any scores or labels, and constructs display layouts such as separate panels or cards. The terminal assigns visual attributes, such as titles and fonts, and prepares a layout tree for rendering on the display device.

### Step 13

The terminal displays the plurality of types of answer information in a comparable manner and presents the final or integrated answer information with emphasis. The input of this step is the prepared layout tree from Step 12, and the output is rendered graphical output on the display device that the user can perceive. The terminal draws multiple answer panels arranged vertically or horizontally, applies highlighting or positioning to the final answer information, and displays control elements, such as buttons for selection and rating. The terminal thereby converts structured data into pixel values and drives the display controller accordingly.

### Step 14

The user reviews the displayed answer information and performs a selection operation or feedback operation. The input of this step is the visual information presented on the terminal screen, and the output is user interaction events such as touches, clicks, or rating inputs. The user taps one of the answer panels to indicate preference, presses a “Helpful” or “Not helpful” button, or adjusts a rating scale. These operations generate event signals that the terminal's input handling module converts into structured feedback information.

### Step 15

The terminal generates feedback information and, optionally, emotion analysis information based on user actions and user input content. The input of this step is the raw interaction events from Step 14 and stored context such as recent conversation history, and the output is a compact representation of user preference and emotional state. The terminal maps the selected answer panel to an answer identifier, tags it as preferred or non-preferred, and may execute an emotion analysis module that computes an emotional label from textual cues, timing, or other signals. The terminal then constructs a feedback data record that includes the prompt sentence identifier, the selected answer identifier, rating values, and the emotion analysis information.

### Step 16

The terminal transmits the feedback information and emotion analysis information to the server. The input of this step is the feedback data record constructed in Step 15, and the output is a network message delivered to the server. The terminal encapsulates the feedback data in a request payload and uses its communication module to send the payload over the network to a designated feedback endpoint on the server.

### Step 17

The server receives the feedback information and emotion analysis information and updates stored records. The input of this step is the feedback message from the terminal, and the output is updated entries in a server-side data store. The server parses the message, associates the feedback and emotion analysis information with the original prompt sentence and answer records using identifiers, and writes the combined data into persistent storage such as a database table or log file. The server may also compute summary statistics, such as counts of selections per model, and store them for monitoring.

### Step 18

The server adjusts operation conditions of the generative AI models and evaluation algorithms based on accumulated feedback information and emotion analysis information.

The input of this step is a set of stored feedback and emotion analysis records and current model or algorithm configuration parameters, and the output is updated configuration values and, optionally, updated model parameter values. The server analyzes patterns, such as which models'answers are frequently selected when the emotional state indicates confusion, and increases or decreases weights used in evaluation scoring or model selection. If training is scheduled, the server loads logged examples into a training pipeline, computes loss values that favor answers marked as preferred, and updates neural network weights through gradient-based optimization, thereby altering subsequent inference behavior.

### Step 19

The server and the terminal prepare for subsequent prompt sentences with improved configuration. The input of this step is the updated operation conditions from Step 18 and any ongoing session context, and the output is a ready-state configuration for the next interaction. The server stores revised weights, sampling parameters, or model selection rules in memory, while the terminal may adjust interface hints or suggestion prompts. When the user inputs a new prompt sentence, the system uses the updated configuration to process the new input, which results in faster convergence to suitable answer information and reduced probability of low-quality responses.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialog systems using a single generative AI model generally produce responses in a uniform style and from a limited viewpoint, and therefore fail to flexibly address diverse user preferences and levels of understanding. Even when multiple generative AI models are available, typical architectures simply select one model or aggregate outputs in an ad hoc manner, without a systematic mechanism for parallel invocation, structured evaluation, and conflict-aware integration. As a result, conventional systems frequently deliver responses that are stylistically mismatched to the user, redundant, or internally inconsistent, and such systems do not provide a technically robust framework for coordinating heterogeneous generative AI models.

Furthermore, conventional systems do not adequately exploit user state information, such as an emotional state, during the evaluation and selection of generated responses. While some systems may detect a rough sentiment, they do not feed this information into a structured evaluation pipeline that algorithmically re-weights and reorganizes candidate responses. This leads to a technical limitation in that the response generation pipeline is effectively static and insensitive to dynamic user conditions, thereby reducing user engagement and comprehension.

From a computer technology perspective, there is a need for improved methods and systems for orchestrating multiple generative AI models in parallel, performing machine-assisted quality evaluation over their outputs, and generating final and integrated responses through similarity and contradiction analysis. Existing server-side architectures do not provide a unified mechanism that (i) automatically constructs style-specific prompt sentences, (ii) executes parallel inference with multiple heterogeneous generative AI models, (iii) evaluates the resulting candidate texts by means of an evaluation generative AI model and rule-based processing, and (iv) integrates the candidate texts into structured response data that can be selectively rendered on a client device, while (v) incorporating user emotional state analysis into the evaluation and selection logic.

Accordingly, there is a need for a computer-implemented solution that improves the technical functioning of server-side natural language processing and response generation pipelines by providing a processor-executed architecture for coordinated prompt generation, parallel model invocation, multi-criteria evaluation, conflict-aware integration, and emotion-aware response selection, such that the resulting system produces higher quality, more consistent, and more personalized responses in an efficient and scalable manner.

The specific processing by the specific processing unit 290 of the data processing device 12 in Application Example 1 is realized by the following means.

The present invention provides a server comprising a processor configured to receive character string information from a user terminal, perform natural language analysis on the character string information to extract intention information and feature information, and generate, on the basis of the intention information and the feature information, a plurality of prompt sentences for causing a plurality of generative AI models to operate in mutually different expression styles and mutually different viewpoints; to transmit, by using a parallel processing mechanism, the plurality of prompt sentences to the plurality of generative AI models in parallel and acquire, from the plurality of generative AI models, a plurality of types of generated information corresponding to the different expression styles and the different viewpoints; to execute, for the plurality of types of generated information, a quality evaluation process by using an evaluation generative AI model and a rule processing mechanism, and calculate evaluation information for each piece of the generated information on the basis of the quality evaluation process; to select, on the basis of the evaluation information, at least one of the plurality of types of generated information as final response information, and integrate the plurality of types of generated information to generate integrated response information by executing similarity calculation processing and contradiction detection processing among the plurality of types of generated information to remove duplicate information and contradiction information; to generate response structure data including the final response information and the integrated response information, and transmit the response structure data to the user terminal so that, at the user terminal, information for the different expression styles and the different viewpoints is selectively displayable; and to input, into the evaluation process for the plurality of types of generated information generated by the plurality of generative AI models, an analysis result of an emotional state of a user as input information, and determine the final response information in consideration of the analysis result of the emotional state. This enables a computer-implemented response generation pipeline in which multiple heterogeneous generative AI models are orchestrated in parallel, their outputs are objectively evaluated and integrated by the server, and emotion-aware final responses and structured multi-style outputs are efficiently provided to the user terminal, thereby improving the technical performance, reliability, and adaptability of the underlying information processing system.

The term “processor” refers to an arithmetic and logic control unit, implemented by one or more hardware computing elements such as a central processing unit, a graphics processing unit, or a programmable logic device, that executes machine-readable instructions to perform information processing operations.

The term “user terminal” refers to an information processing device operated by a user, such as a portable communication device, a wearable display device, or a general-purpose computing device, that transmits input information to a server and displays response information received from the server.

The term “character string information” refers to digital text data composed of one or more characters, symbols, or tokens, representing user input content such as queries, commands, or natural language utterances.

The term “natural language analysis” refers to a processing operation in which input text data is analyzed using computational linguistic techniques, including at least one of tokenization, part-of-speech tagging, syntactic parsing, semantic analysis, or named entity recognition, to derive structured information from natural language.

The term “intention information” refers to structured data representing an inferred purpose, goal, or request of a user, derived from analysis of user input and indicating, for example, whether the user seeks an explanation, a summary, a recommendation, or another specific type of response.

The term “feature information” refers to structured data elements extracted from input text, including at least one of keywords, entities, topics, contextual attributes, or other characteristic indicators used to condition subsequent processing.

The term “prompt sentence” refers to a machine-interpretable text sequence, including instructions, constraints, or contextual content, provided as input to a generative AI model to control or guide the generation of output data.

The term “generative AI model” refers to a machine-learned computational model, such as a neural network language model, configured to generate output data including natural language text or other content in response to an input sequence such as a prompt sentence.

The term “expression style” refers to a manner of presenting content, including at least one of narrative style, technical style, conversational style, formal style, or informal style, characterized by differences in vocabulary, tone, syntax, or rhetorical structure.

The term “viewpoint” refers to a perspective or stance from which information is presented, including at least one of expert viewpoint, layperson viewpoint, educational viewpoint, or narrative viewpoint, characterized by assumptions about knowledge level, focus, or role.

The term “parallel processing mechanism” refers to a control structure, implemented in hardware or software, that schedules and executes multiple processing tasks concurrently or overlapping in time, such as by using multithreading, multiprocessing, or distributed processing.

The term “generated information” refers to output data produced by a generative AI model in response to a prompt sentence, including at least one of natural language text, structured text, or metadata describing such output.

The term “quality evaluation process” refers to a set of computational operations for assessing characteristics of generated information, including at least one of accuracy, clarity, consistency, completeness, or usefulness.

The term “evaluation generative AI model” refers to a generative AI model that is used not primarily to respond directly to a user, but to analyze and evaluate candidate responses or other generated information, typically in accordance with instructions contained in an evaluation prompt sentence.

The term “rule processing mechanism” refers to a processing component that applies predetermined logical rules, heuristics, or constraints, implemented for example as conditional statements, scoring functions, or pattern-matching procedures, to evaluate or filter data.

The term “evaluation information” refers to numerical scores, categorical labels, or other metrics computed for generated information during the quality evaluation process and indicating the relative quality or suitability of each candidate output.

The term “final response information” refers to at least one selected portion of generated information that has been chosen, on the basis of evaluation information and optional additional conditions, to be provided as a primary response to a user.

The term “integrated response information” refers to composite output data generated by combining multiple pieces of generated information, where duplicate or inconsistent portions are reduced, removed, or reconciled to form a coherent whole.

The term “similarity calculation processing” refers to computational operations for estimating the degree of similarity between pieces of text or other data, including at least one of vector-space comparison, distance measurement, or correlation computation.

The term “contradiction detection processing” refers to computational operations for identifying conflicting or mutually inconsistent statements among multiple pieces of generated information, including at least one of rule-based comparison, logical inconsistency checking, or model-based contradiction classification.

The term “duplicate information” refers to information segments that are substantially redundant or overlapping in content relative to other segments, as determined by similarity calculation processing or other comparison techniques.

The term “contradiction information” refers to information segments that conflict with, negate, or are logically incompatible with other segments, as determined by contradiction detection processing.

The term “response structure data” refers to structured digital data representing organization of response content, including at least one of section identifiers, style labels, viewpoint labels, metadata, and references to associated response segments.

The term “selectively displayable” refers to a property of data presented on a user terminal whereby different portions or versions of response information can be independently displayed, hidden, or switched according to user selection or interface control.

The term “emotional state of a user” refers to information representing an affective condition of a user, such as positive, negative, neutral, or more fine-grained emotional categories, derived from analysis of user input or related signals.

The term “analysis result of an emotional state” refers to structured output produced by an emotion detection or sentiment analysis process, indicating a determined or estimated emotional state of a user in a form usable as input to other processing components.

The term “overlap information” refers to data indicating the degree or extent to which portions of multiple pieces of generated information share similar or identical content.

The term “difference information” refers to data indicating the degree or extent to which portions of multiple pieces of generated information diverge or are distinct in content.

The term “information element” refers to a minimal or unitary piece of information, such as a sentence, clause, phrase, or structured record field, that can be individually selected, weighted, or combined during integration processing.

The term “weighting” refers to an operation of assigning a numerical or relative importance value to an information element or other data item, such that items with higher weights have greater influence on a selection, ranking, or integration outcome.

The term “evaluation prompt sentence” refers to a prompt sentence that includes one or more pieces of generated information as input content and contains instructions to an evaluation generative AI model to produce evaluation indices or judgments regarding such information.

The term “evaluation indices” refers to quantitative or qualitative measures, such as scores, ratings, or categorical assessments, that characterize properties including accuracy, clarity, usefulness, or other quality aspects of generated information.

In one embodiment, a server cooperates with a terminal operated by a user to implement a multi-model response generation system. The server includes a processor, a memory device, a non-volatile storage device, a network interface, and, in some embodiments, an accelerator such as a graphics processing unit. The terminal includes a display device, an input device, a network communication module, and an optional audio output device. The user operates the terminal to transmit text information to the server and to receive and display structured response information.

The server executes an operating system and an application framework that hosts a network service. The server executes, for example, a web application framework and a numerical computation library that provides tensor operations and automatic differentiation. The server stores one or more generative AI models and one or more evaluation generative AI models in the storage device. The server loads these models into the memory device for inference. Each generative AI model is implemented, for example, as a transformer-based neural network language model including an embedding layer, a plurality of self-attention layers, a feedforward layer, and a softmax output layer. The server stores model parameters such as attention weight matrices, feedforward weight matrices, and layer normalization parameters in the storage device.

The server trains the generative AI models using a corpus of training data consisting of text sequences. The server uses a supervised or self-supervised learning procedure in which the server minimizes a loss function, such as a cross-entropy loss, between predicted token distributions and ground truth tokens. The server performs weight updates using an optimization algorithm such as stochastic gradient descent or an adaptive variant. The server may perform data augmentation by masking, shuffling, or re-segmenting tokens to improve robustness. The server may fine-tune different generative AI models on different subsets of the training data to obtain models specialized in different expression styles or viewpoints. The server stores, for example, a first generative AI model that has been fine-tuned on narrative or literary texts, a second generative AI model that has been fine-tuned on technical documents, and a third generative AI model that has been fine-tuned on conversational dialogues. The server stores an evaluation generative AI model that has been fine-tuned to rate text quality according to criteria such as accuracy, clarity, and usefulness. The server configures each model with a fixed vocabulary, positional encoding scheme, and maximum sequence length. The server defines, for each model, a temperature parameter, a top-k parameter, or a nucleus sampling parameter that controls randomness in text generation. The server stores program instructions that implement a natural language analysis pipeline. The server uses, for example, a natural language processing library to perform tokenization, sentence boundary detection, part-of-speech tagging, dependency parsing, and named entity recognition. The server uses a classifier model, such as a transformer-based classifier, to infer user intention categories and to compute one or more feature vectors that represent semantic content of user input. The server stores these feature vectors in an internal data structure, such as a record containing fields for intention information, feature information, and contextual metadata.

The terminal executes a user interface program that provides an input field and control elements. The terminal transmits character string information entered by the user, including the user's question or request, to the server via a network protocol. The terminal receives response structure data from the server and renders sections corresponding to different expression styles and viewpoints. The terminal allows the user to select which sections to display. The terminal may use a text-to-speech function to output the selected section as audio. The server receives, via the network interface, the character string information transmitted from the terminal. The server stores the character string information, associated with a session identifier, in the memory device. The server performs natural language analysis on the character string information and extracts intention information and feature information. The server then constructs a plurality of prompt sentences tailored to different generative AI models. The server uses prompt templates stored in the storage device. Each template specifies an expression style and viewpoint.

The server generates, for a narrative-style generative AI model, a prompt sentence such as:
“Describe the latest space exploration missions in a literary, narrative style. Use vivid imagery and emotional expressions while explaining recent discoveries and missions.”

The server generates, for a technical-style generative AI model, a prompt sentence such as: “Explain the latest space exploration technologies and missions in a detailed technical style. Include information about launch vehicles, propulsion systems, spacecraft architecture, scientific instruments, and mission timelines.”

The server generates, for a conversational-style generative AI model, a prompt sentence such as:
“Explain the latest space exploration in a simple, friendly, everyday conversational tone. Imagine you are talking to a curious friend with no technical background.”

The server embeds, within these prompt sentences, the extracted keywords and entities, such as specific mission names or topics, and may append constraints on length, level of detail, or target audience. The server encodes the prompt sentences into token sequences using the tokenizer associated with each generative AI model. The server creates internal data structures that pair each token sequence with a model identifier and generation parameters. The server uses a parallel processing mechanism to invoke the plurality of generative AI models. The server establishes multiple execution threads or processes and assigns each prompt sentence to a respective generative AI model. The server executes each generative AI model as a forward-propagation computation over the transformer network. The server performs matrix multiplications between token embeddings and weight matrices, computes self-attention scores using query, key, and value vectors, and applies non-linear activation functions. The server generates, token by token, a sequence of output tokens until an end-of-sequence condition is satisfied. The server decodes the output tokens into text strings and stores them as generated information for each model.

The server uses an evaluation generative AI model and a rule processing mechanism to perform a quality evaluation process. The server constructs an evaluation prompt sentence that concatenates or references the plurality of generated texts and specifies evaluation criteria. The server may generate an evaluation prompt sentence such as:
“You are an evaluator. Several AI answers about the latest space exploration are given below. For each answer, rate accuracy, clarity, and usefulness on a scale from 1 to 10 and briefly justify your scores. Then recommend which answer is best overall.”

The server encodes this evaluation prompt sentence and input texts into tokens and feeds them to the evaluation generative AI model. The server decodes the model's output into structured evaluation information, such as numeric scores and a ranking. The server applies a rule processing mechanism that enforces constraints, such as discarding responses that lack required keywords or exceed a length threshold. The server stores evaluation information in a data structure linked to each piece of generated information.

The server obtains, in parallel or in sequence, an analysis result of an emotional state of the user. The server may perform sentiment analysis on the user's input text using a classifier model. The server represents the emotional state as a vector of scores across predefined emotion categories. The server uses this analysis result as a factor in re-weighting evaluation scores. For example, when the emotional state indicates confusion or anxiety, the server increases the weight of clarity and reduces the weight of technical density.

The server computes similarity between different pieces of generated information using an embedding model, such as a sentence encoder. The server maps each sentence or segment into a vector space and calculates similarity using a distance or similarity metric. The server identifies duplicate information segments when similarity exceeds a threshold. The server detects contradiction information by applying contradiction detection processing. The server may pass pairs of sentences into a classifier model trained on natural language inference tasks to output labels such as “entailment,” “neutral,” or “contradiction.” The server flags segments with a contradiction label as conflicting.

The server combines similarity calculation processing and contradiction detection processing to integrate the plurality of generated texts. The server removes segments that are highly redundant or contradictory and constructs integrated response information by selecting non-redundant, non-contradictory segments with high evaluation scores. The server forms information elements, such as sentence-level or paragraph-level units, and assigns weights based on evaluation indices and emotional state analysis. The server arranges these elements into a coherent structure, optionally grouping them by style or viewpoint.

The server selects at least one piece of generated information as final response information based on evaluation indices and emotional state. For example, when evaluation indices indicate that a technical answer has the highest accuracy but the user's emotional state suggests a preference for simplicity, the server selects both a simplified conversational answer as the primary display and a technical answer as an optional section. The server generates response structure data that includes references to the final response information and the integrated response information, as well as metadata describing expression styles and viewpoints.

The terminal receives the response structure data and presents different sections as separate selectable areas on the display device. The terminal allows the user to switch between a literary explanation, a technical explanation, and a conversational explanation. The terminal may display indicators showing which section is recommended based on the user's emotional state. The user can therefore choose to view detailed technical content or to focus on simplified content, while all content originates from coordinated processing by multiple generative AI models.

The system provides technical improvements in server-side information processing. The server reduces latency by executing multiple generative AI models in parallel instead of sequentially. The server improves response quality and consistency by evaluating and integrating outputs using specified algorithms rather than selecting a single model output without verification. The server reduces network load and repeated computation by integrating and deduplicating responses before transmission, thereby transmitting a compact response structure data set instead of multiple full responses. The server improves accuracy and robustness by using dedicated evaluation models and rule sets that detect contradictions and filter out low-quality outputs.

The server uses non-conventional processing steps that differ from human manual evaluation. The server evaluates text using vector-space similarity and trained contradiction detection models, applies numerical weighting based on emotion analysis, and conducts multi-criteria optimization to construct final and integrated responses. The server uses learning-based models with parameterized functions and explicitly defined loss functions, enabling systematic and repeatable behavior not achievable by simple business rules or human heuristics. The server optimizes computational resources by sharing embedding computations across similarity and contradiction detection modules and by caching intermediate vector representations.

In a variation, the server deploys the generative AI models across multiple machines in a distributed environment. The server partitions large models across accelerator devices and uses pipeline parallelism or model parallelism to support longer sequences or larger batch sizes. The server may adjust decoding parameters dynamically based on intermediate evaluation signals, thus reducing computation by terminating low-quality generation early. The server may compress response structure data using a lossless compression algorithm prior to transmission to further reduce bandwidth.

In another embodiment, the server uses different types of generative AI models, such as encoder-decoder architectures for summarization, or autoregressive decoders for free-form generation. The server may include rule-based modules for specific domains, such as scientific or legal content, and may combine outputs from domain-specific models and general models. The server may adapt prompt templates based on usage history stored in a user profile, further improving personalization and performance.

Through these configurations, the server improves the functioning of the computer system as a whole. The server restructures the flow of data through multiple neural networks, evaluation modules, and integration algorithms in a way that increases processing speed, enhances accuracy and consistency, and reduces resource consumption. The terminal benefits from receiving well-structured, compact response data that can be selectively displayed or rendered, providing a technical effect beyond mere automation of human drafting or manual evaluation of responses.

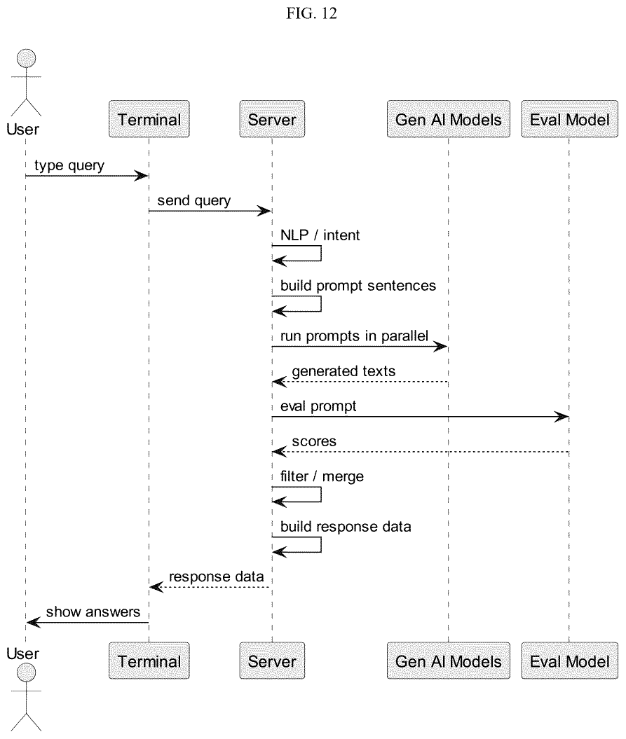

The following describes the processing flow using FIG. 12.

### Step 1

The user operates the terminal to input a text query, and the terminal transmits the query to the server.

The terminal receives, as input, user operations such as keystrokes or voice-to-text results and converts these operations into character string information including a query sentence and optional metadata (for example, language, timestamp, or session ID). The terminal packages this information into a request message and sends the request message to the server via a network interface using a communication protocol.

### Step 2

The server receives the request message from the terminal and stores the character string information in memory.

The server accepts, as input, the network packet containing the character string information and metadata, parses the packet to extract the payload, and verifies the format and required fields. The server writes the extracted character string information and associated metadata into an internal data structure in volatile storage, thereby producing a normalized request record as output that is ready for subsequent analysis.

### Step 3

The server performs natural language analysis on the character string information to derive intention information and feature information.

The server takes, as input, the character string stored in the request record and applies a natural language processing pipeline that executes tokenization, sentence segmentation, part-of-speech tagging, dependency parsing, and named entity recognition. The server additionally applies a classifier model to the tokenized sequence to compute an intention label and to generate one or more semantic feature vectors. The server combines the intention label, recognized entities, keywords, and feature vectors into a structured representation, and outputs this representation as intention information and feature information associated with the request.

### Step 4

The server constructs a plurality of prompt sentences for different generative AI models based on the intention information and feature information.

The server uses, as input, the intention information, feature information, and stored prompt templates that specify different expression styles and viewpoints. The server selects appropriate templates (for example, literary, technical, conversational) and inserts extracted entities, keywords, and context phrases into template placeholders. The server produces, as output, a set of prompt sentences, each annotated with a target generative AI model identifier and style metadata, such as a narrative prompt, a technical prompt, and a conversational prompt.

### Step 5

The server prepares model-specific input data structures by tokenizing the prompt sentences for each generative AI model.

The server receives, as input, the textual prompt sentences and the tokenizer configuration for each generative AI model. The server applies the corresponding tokenizer to each prompt sentence to convert the text into a sequence of token IDs, and attaches positional encodings and attention masks as required by the model architecture. The server outputs, for each generative AI model, a model-ready input object that includes a token sequence, positional indices, and generation parameters such as temperature or top-k values.

### Step 6

The server invokes the plurality of generative AI models in parallel using the prepared input objects.

The server takes, as input, the model-ready input objects and schedules separate execution tasks for each generative AI model on CPU or accelerator hardware. The server feeds the token sequences into the transformer-based networks, performs the forward-propagation computations layer by layer, and iteratively decodes output tokens according to a generation algorithm. The server aggregates the generated token sequences for each model and decodes them into text strings, outputting a plurality of generated texts, each corresponding to a specific expression style and viewpoint.

### Step 7

The server performs basic post-processing on the generated texts and normalizes them into a common internal format.

The server receives, as input, the raw generated texts from the generative AI models and applies formatting operations such as trimming whitespace, normalizing line breaks, and removing leading or trailing boilerplate phrasing. The server splits the texts into sentence or paragraph units as information elements and attaches style labels and model identifiers. The server outputs a unified collection of generated information elements, each tagged with its origin and style.

### Step 8

The server computes an analysis result of an emotional state of the user from the original character string information.

The server uses, as input, the user's original text and optional context such as previous turns in a dialog. The server applies a sentiment or emotion classifier to the text, converting the text into feature vectors and feeding them through a trained neural network or statistical model. The server generates emotion scores for predefined categories (for example, positive, neutral, negative, or more granular emotions) and outputs the analysis result as an emotional state vector associated with the current request.

### Step 9

The server constructs an evaluation prompt sentence for an evaluation generative AI model and prepares evaluation input data.

The server takes, as input, the plurality of generated texts and style labels, and organizes them into a formatted evaluation context that includes each candidate answer and explicit evaluation instructions. The server generates an evaluation prompt sentence that describes the evaluation task, attaches the candidate texts, and encodes the combined text using the tokenizer for the evaluation generative AI model. The server outputs an evaluation model input object containing the evaluation prompt tokens and associated configuration parameters.

### Step 10

The server executes the evaluation generative AI model to obtain evaluation information for each generated text.

The server receives, as input, the evaluation model input object and feeds it through the evaluation generative AI model, executing the forward-propagation computations across its layers. The server decodes the model's output into textual or structured ratings, parses the ratings to extract scores for accuracy, clarity, and usefulness, and maps these scores back to the corresponding generated texts. The server outputs evaluation information for each candidate text, represented as numerical indices and qualitative comments.

### Step 11

The server applies rule-based processing to refine the evaluation information and filter the generated texts.

The server uses, as input, the evaluation information, the generated information elements, and the emotional state vector. The server executes a rule engine that applies predefined conditions such as minimum score thresholds, required keyword presence, length constraints, and style constraints conditioned on emotional state. The server may lower thresholds or increase clarity weight when the emotional state indicates confusion or stress. The server outputs a filtered and re-weighted set of evaluation scores and a subset of generated texts that satisfy the rules.

### Step 12

The server performs similarity calculation processing to identify duplicate information among the generated texts.

The server receives, as input, the filtered generated information elements and computes vector embeddings for each element using a sentence-level encoder. The server calculates pairwise similarity scores using a similarity metric such as cosine similarity or Euclidean distance. The server compares these scores to a predetermined threshold to determine which elements are redundant or highly overlapping, and marks these elements with duplicate flags. The server outputs a list of unique primary elements and associated duplicate relationships.

### Step 13

The server executes contradiction detection processing to identify conflicting information among the generated texts.

The server uses, as input, pairs or groups of information elements from different generated texts. The server applies a contradiction classifier that receives pairs of sentences and outputs labels indicating entailment, neutrality, or contradiction. The server analyzes these labels and extracts elements that are inconsistent with others. The server marks elements associated with contradictions and computes reliability scores that penalize contradictory segments. The server outputs an updated set of elements with contradiction annotations.

### Step 14

The server integrates the non-duplicate, non-contradictory information elements into integrated response information.

The server takes, as input, the unique primary elements, their evaluation scores, duplicate flags, contradiction annotations, and the emotional state vector. The server ranks the elements by combined scores that include evaluation indices, redundancy penalties, contradiction penalties, and emotion-dependent weights. The server selects a subset of high-scoring elements and orders them into a coherent structure, optionally grouped by style or viewpoint. The server concatenates or otherwise combines these ordered elements to produce an integrated response text and outputs this text as integrated response information.

### Step 15

The server selects at least one generated text as final response information based on evaluation information and emotional state.

The server uses, as input, the evaluation scores per entire generated text, the emotion-adjusted weights, and the style metadata. The server determines which style or combination of styles is most suitable for the user's current emotional state and intention, and selects one or more generated texts as final response information. The server may, for example, select a conversational answer as primary and a technical answer as secondary when the emotional state suggests a need for simplicity. The server outputs identifiers and content for the selected final response information.

### Step 16

The server generates response structure data that includes the final response information and the integrated response information.

The server receives, as input, the integrated response information, the final response information, and their associated metadata such as style labels, viewpoints, and evaluation scores. The server constructs a structured representation that defines sections for each style, links to the integrated response, and flags indicating recommended sections. The server encodes this representation into a response structure data object containing fields for each section's text and metadata, and outputs this object as the server's response payload.

### Step 17

The server transmits the response structure data to the terminal, and the terminal renders selectable sections for the user.

The server uses, as input, the response structure data and the session identifier, encapsulates the data into a response message, and sends the message to the terminal over the network.

The terminal receives the response message, parses the response structure data, and maps each section to a user interface component such as a tab or panel. The terminal updates the display to show the primary final response and enables user controls for switching between different styles or viewpoints, thereby outputting rendered visual or audio content for the user.

### Step 18

The user interacts with the rendered responses and optionally initiates further queries, closing the loop with the server.

The user views or listens to the displayed sections on the terminal and may select alternative sections or request more detail. The terminal treats these user interactions as new input, generating additional character string information or control commands. The terminal sends this new input back to the server, which reuses the described processing flow to refine or extend the responses, thereby producing subsequent outputs that are informed by previous evaluation, integration, and emotional state analysis.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems that utilize a single generative AI model to respond to a user's prompt sentence suffer from several technical limitations. A single model often produces responses that are biased, inconsistent, or factually incorrect, and such systems lack robust internal mechanisms to validate or rank the generated content. As model size and complexity increase, naive scaling of a single model does not proportionally improve reliability. Instead, it increases computational cost without providing a systematic way to select high-quality responses.

Moreover, when multiple generative AI models are used in parallel in existing architectures, they are typically orchestrated in an ad hoc manner. For example, some systems merely select a response from one model based on fixed priority rules, or perform superficial voting without structured, machine-readable evaluation criteria. These approaches fail to leverage the models'capabilities to rigorously evaluate each other's outputs using explicit scoring schemes, and they do not define a reproducible, programmatic pipeline for cross-evaluation, statistical aggregation, and final selection. As a result, the computing resources of multiple models are not efficiently harnessed to improve the technical quality of the generated information.

In addition, conventional dialog systems that attempt to incorporate user emotional state often handle emotion at a superficial post-processing layer, such as adjusting only the wording or style after a response has already been selected. In such architectures, the emotional state does not influence the internal selection or synthesis of responses at the model-orchestration level. This leads to a technical mismatch between the generation pipeline and the user's current state, because the underlying model selection, scoring, and synthesis remain emotion-agnostic, and emotion is only “painted on” after the fact.

From a computer-technology standpoint, there is a need for an improved server-side architecture and processing method that: (i) executes parallel inference on multiple generative AI models; (ii) automatically constructs structured evaluation prompt sentences and obtains machine-readable scores regarding validity, consistency, and clarity; (iii) performs statistical or weighted aggregation of those scores to select or synthesize a final response; and (iv) programmatically integrates the user's emotional state into both the evaluation and generation stages. Such an architecture should provide a concrete, technical improvement to the way computing resources (processor, memory, and model APIs) are orchestrated, thereby enhancing the reliability, robustness, and user-appropriateness of dialog responses produced by generative AI models.

The specific processing by the specific processing unit 290 of the data processing device 12 in Example 2 is realized by the following means.

The present invention provides a server comprising a processor configured to receive, from a user terminal, a prompt sentence and associated attribute information, to store the prompt sentence and the associated attribute information as request information, to transmit in parallel the prompt sentence to a plurality of generative AI models, to acquire and normalize a plurality of candidate response pieces generated by the plurality of generative AI models, to generate, for each of the plurality of candidate response pieces, an evaluation prompt sentence including an original prompt sentence and the corresponding candidate response piece, to transmit the evaluation prompt sentence to the plurality of generative AI models, to acquire evaluation information including numerical scores relating to at least validity, consistency, and clarity and including an evaluation comment, to execute at least one of a statistical aggregation process and a weighted averaging process on numerical scores included in the evaluation information to calculate a comprehensive evaluation score for each of the plurality of candidate response pieces, to select at least one final response piece based on the comprehensive evaluation score, to generate, when a plurality of candidate response pieces each having a comprehensive evaluation score satisfying a predetermined condition exist, an integration prompt sentence that includes the plurality of candidate response pieces and the original prompt sentence, to transmit the integration prompt sentence to a generative AI model in order to cause the generative AI model to generate integrated response information, to determine the integrated response information as the final response piece, to analyze an emotional state of the user based on at least one of voice information, image information, and operation history information of the user, to provide an analysis result of the emotional state as an additional condition to at least one of the prompt sentence and the evaluation prompt sentence supplied to the plurality of generative AI models, and to transmit the final response piece to the terminal and cause the final response piece to be presented in a dialog with the user. This enables the server to technically improve computer operation by orchestrating multiple generative AI models through structured cross-evaluation and emotion-aware aggregation, thereby enhancing response reliability, consistency, and user-appropriateness beyond what is achievable with a single-model or non-evaluative architecture.

The term “system” refers to an arrangement of at least one server device and at least one terminal device, including associated hardware and software components, that cooperatively execute the processing described in the claims.

The term “processor” refers to one or more hardware processing units, such as a central processing unit or a graphics processing unit, and control circuits that execute instructions to perform the functions specified in the claims.

The term “terminal” refers to an electronic device operated by a user, such as a computing device or communication device, that is configured to transmit a prompt sentence and receive a response from the server.

The term “user” refers to a human operator or an entity that interacts with the system through the terminal to input prompt sentences and receive responses.

The term “prompt sentence” refers to text data, including a question, instruction, or request, that is input by the user and supplied to one or more generative AI models to cause generation of a response.

The term “attribute information” refers to supplementary data associated with a prompt sentence, including at least one of user identification information, language settings, time information, or application context information.

The term “request information” refers to data stored in the server that includes at least the prompt sentence and the associated attribute information received from the terminal.

The term “storage apparatus” refers to a hardware storage component, such as a memory device or a storage device, configured to store request information, candidate response pieces, evaluation information, and other data used by the processor.

The term “generative AI model” refers to a machine learning model, such as a neural network-based language model, that generates new text or other output data in response to input data including a prompt sentence.

The term “candidate response piece” refers to text or structured data generated by a generative AI model based on a prompt sentence, before final selection as a system response.

The term “normalize” refers to processing applied to a candidate response piece to convert the candidate response piece into a standardized internal format, including at least one of trimming characters, unifying line breaks, or removing disallowed content.

The term “evaluation prompt sentence” refers to a prompt supplied to a generative AI model that includes at least an original prompt sentence and a candidate response piece, and that instructs the generative AI model to evaluate the candidate response piece.

The term “evaluation information” refers to machine-readable data output by a generative AI model in response to an evaluation prompt sentence, including at least numerical scores and optionally comments regarding quality of a candidate response piece.

The term “numerical score” refers to a numeric value output by a generative AI model that quantifies quality of a candidate response piece according to a predetermined criterion, such as validity, consistency, clarity, or overall quality.

The term “validity” refers to a property indicating the degree to which contents of a candidate response piece are factually or logically correct in view of the prompt sentence.

The term “consistency” refers to a property indicating the degree to which contents of a candidate response piece are internally coherent and do not conflict with the prompt sentence or with themselves.

The term “clarity” refers to a property indicating the degree to which contents of a candidate response piece are understandable, well-structured, and unambiguous to a typical reader.

The term “evaluation comment” refers to descriptive text generated by a generative AI model that explains or supports the numerical scores assigned to a candidate response piece.

The term “statistical aggregation process” refers to an operation performed by the processor that combines multiple numerical scores using a statistical method, such as averaging, trimming outliers, or computing a median.

The term “weighted averaging process” refers to an operation performed by the processor that calculates a combined numerical score by multiplying each numerical score by a corresponding weight and dividing a sum of weighted scores by a sum of the weights.

The term “comprehensive evaluation score” refers to a final numerical value computed for each candidate response piece by applying at least one of the statistical aggregation process and the weighted averaging process to multiple numerical scores.

The term “final response piece” refers to one or more response texts or data selected or synthesized by the processor based on comprehensive evaluation scores, and intended to be presented to the user.

The term “predetermined condition” refers to one or more rules defined in advance, such as a threshold value or rank, that determine whether multiple candidate response pieces are to be subjected to integration processing.

The term “integration prompt sentence” refers to a prompt supplied to a generative AI model that includes at least a plurality of candidate response pieces and an original prompt sentence, and that instructs the generative AI model to generate integrated response information.

The term “integrated response information” refers to a response generated by a generative AI model in response to an integration prompt sentence, in which contents of multiple candidate response pieces are combined or reconciled.

The term “dialog” refers to an interactive exchange of information between the user and the system, including repeated transmission of prompt sentences and presentation of response information.

The term “voice information” refers to audio data representing speech or other sounds produced by the user and captured by the terminal or another input device.

The term “image information” refers to visual data, such as still images or video frames, that include a depiction of the user or user-related content captured by the terminal or another imaging device.

The term “operation history information” refers to data indicating patterns of user interaction with the terminal or system, including at least input operations, selection operations, and timing information.

The term “emotional state” refers to an inferred mental or affective condition of the user, such as calmness, stress, satisfaction, or dissatisfaction, estimated based on at least one of voice information, image information, and operation history information.

The term “analysis result” refers to data produced by the processor that represents a detected or inferred emotional state of the user, optionally including intensity, category, or confidence information.

The term “additional condition” refers to constraint information, parameter information, or context information that is appended to or associated with a prompt sentence or evaluation prompt sentence in order to influence behavior of a generative AI model.

The term “tone” refers to stylistic characteristics of language in response information, such as formality, politeness level, emotional expressiveness, or directness.

The term “expression density” refers to a degree of detail or brevity in a response, including at least length, level of elaboration, and granularity of explanation.

The term “presentation format” refers to a structural style in which response information is output to the user, including at least text layout, use of lists, headings, or other formatting conventions.

The term “server” refers to a computing apparatus, which may include the processor and the storage apparatus, that receives request information from the terminal, communicates with generative AI models, performs evaluation and aggregation processing, and transmits response information back to the terminal.

In one embodiment, a server implements the claimed system by executing a set of software modules on a hardware platform that includes at least one central processing unit, volatile memory, non-volatile storage, and a network interface. The server uses a general-purpose operating system such as a UNIX-like operating system and runs middleware including a web server, an application server, and model client libraries. The server communicates with at least one terminal over a packet-switched network using a transport protocol such as Transmission Control Protocol and an application protocol such as Hypertext Transfer Protocol over Transport Layer Security.

The terminal operates as a user interface device. The terminal is, for example, a mobile computing device, a tablet device, or a personal computing device equipped with a display unit, an input unit, a microphone, and optionally a camera. The terminal runs a client application, such as a web browser or a dedicated native application, that presents graphical user interface components implemented using a user interface toolkit and a scripting engine. The terminal transmits a prompt sentence and associated attribute information to the server in a structured message format, and receives and displays response information generated by the server.

The user interacts with the system by operating the terminal. The user inputs a prompt sentence as free-form natural language text into a text entry field. Example prompt sentences include “Please tell me about the latest technology trends.” and “Please tell me your view on the future of AI technologies.” The terminal may augment the prompt sentence with attribute information such as language preference, device type, and session identifier, and transmits this information as request information to the server.

The server stores the request information in a storage apparatus, which may include a relational database management system as well as a key-value store. The storage apparatus maintains data structures such as a request table, a candidate response table, and an evaluation information table. Each table is indexed by a request identifier. For example, the request table stores the prompt sentence, attribute information, and timestamps. The candidate response table stores candidate response pieces generated by multiple generative AI models and associates each candidate with a model identifier. The evaluation information table stores numerical scores and comments produced during cross-evaluation.

The server communicates with a plurality of generative AI models. Each generative AI model in this embodiment is a trained neural network-based language model that approximates a conditional probability distribution over token sequences given input tokens. The server can deploy some models locally using a machine learning framework such as a tensor computation framework, and can access other models remotely through model service application programming interfaces. Each generative AI model is implemented as a multi-layer neural network architecture, such as a transformer architecture with self-attention mechanisms, multiple attention heads, feedforward sublayers, layer normalization, and residual connections. The models are pre-trained on large text corpora and may be fine-tuned on task-specific datasets.

The server uses specific model configurations. For example, a first generative AI model may be configured with a particular number of transformer layers, a particular hidden dimension size, a particular number of attention heads, and a particular vocabulary size. A second generative AI model may differ in these parameters and in its training corpus and objective. Each model uses tokenization to convert the prompt sentence and additional text into integer token sequences, and then performs matrix multiplications and non-linear activations to compute output token distributions.

The server uses a client library to send prompts and receive outputs from each generative AI model. To ensure reproducible and machine-readable evaluation, the server constructs evaluation prompt sentences and integration prompt sentences using fixed templates that embed both the original prompt sentence and candidate responses, and that require output in specified formats. These templates define explicit evaluation criteria, such as validity, consistency, and clarity, and instruct the generative AI models to output structured numerical scores and textual comments.

The server normalizes candidate response pieces before evaluation. Normalization includes operations such as trimming leading and trailing whitespace, converting line endings to a canonical representation, normalizing character encodings, and applying content filters. The server stores normalized candidate response pieces in memory associated with the corresponding request identifier, and passes these normalized texts into evaluation prompt sentences.

For cross-evaluation, the server uses multiple generative AI models as evaluators. The server embeds each candidate response piece into an evaluation prompt sentence together with the original prompt sentence and explicit instructions such as “Rate validity, consistency, and clarity on a scale of 1 to 10 and provide an overall score.” When a generative AI model receives such an evaluation prompt sentence, the model encodes the full input including the prompt sentence, the candidate response, and the evaluation instructions into tokens, and processes the token sequence using its transformer layers. The model produces output tokens that represent a structured response, such as a sequence describing numerical scores and a brief comment.

In one training scenario, a generative AI model used for evaluation may be fine-tuned on a dataset consisting of question-answer pairs and human-labeled scores for validity, consistency, and clarity. During fine-tuning, the server or an offline training system uses a loss function that includes a cross-entropy term between the model output tokens and a target textual representation of scores and comments. Optionally, a regression loss term may be applied to enforce precise numerical outputs. Gradient descent and a stochastic optimization algorithm such as Adam update the model's weight parameters. Through this process, the evaluation model learns to map input question-answer contexts to structured quality assessments.

The server parses the evaluation output by applying a deterministic parser that extracts numerical scores and evaluation comments. For example, if the evaluation output adheres to a known pattern, the server uses regular expressions or a structured decoder to find values for validity, consistency, clarity, and overall score. The server stores each piece of evaluation information in association with both the candidate response identifier and the evaluator model identifier. This representation allows the server to construct for each candidate response a vector of scores from multiple evaluators.

To aggregate the scores, the server executes numerical operations on the stored score vectors. The server can compute simple averages, weighted averages, trimmed means, or robust statistical measures such as medians. The server may maintain configuration parameters defining per-model weights, reflecting trust levels or performance profiles for each generative AI model. For instance, the server may apply a weighting scheme in which a particular generative AI model's evaluation scores receive a higher weight when computing the comprehensive evaluation score. The aggregation computation is implemented using numerical libraries optimized for vector and matrix operations, thereby improving computational efficiency compared to ad hoc or manual selection.

If multiple candidate response pieces achieve comprehensive evaluation scores above a threshold or within a certain range of the maximum score, the server executes an integration operation. The server constructs an integration prompt sentence that includes the original prompt sentence and a subset of high-scoring candidate response pieces. The integration prompt sentence instructs a generative AI model to resolve conflicts, remove redundancy, and synthesize a coherent combined response. The target model tokenizes this input, applies its internal transformer computation to integrate information across the candidate responses, and generates a new sequence of tokens representing integrated response information. The server decodes these tokens back into text and stores this integrated response as a special candidate, which can be designated as the final response piece.

The server determines a final response piece based on the comprehensive evaluation scores and, when applicable, the quality of the integrated response information. The server then adjusts stylistic attributes of the final response piece according to the user's emotional state. The server may transform the final response piece by rewriting certain phrases, expanding or compressing explanations, or altering politeness levels, guided by transformation rules and additional calls to generative AI models with style-adjustment instructions. These transformations remain grounded in the same data structures and are tracked with version identifiers.

The server analyzes the user's emotional state by processing signals such as voice information, image information, and operation history. For voice information, the server applies an audio preprocessing pipeline including sampling, framing, windowing, and feature extraction. The server extracts acoustic features such as pitch, energy, spectral flux, and mel-frequency cepstral coefficients. A neural network-based classifier, such as a convolutional or recurrent network, takes these features as input and outputs probabilities over emotional categories. The classifier is trained offline using a labeled dataset of speech segments and associated emotion labels, with a loss function such as cross-entropy, and is optimized by gradient descent.

For image information, the server or the terminal captures frames from a camera. The server applies an image preprocessing pipeline including resizing, normalization, and optionally face detection. The server feeds facial regions into a convolutional neural network trained to estimate emotional states based on facial expressions. Again, training uses a labeled dataset and a supervised learning objective.

For operation history information, the server logs user interactions, such as typing speed, frequency of corrections, pauses between inputs, and navigation patterns within the interface. The server computes statistical features over a session, such as average inter-key interval, variance of response time, and frequency of abrupt cancellations. These features are passed into a machine learning classifier such as a gradient boosting model or a neural network that predicts an emotional state distribution.

The server may combine outputs from voice-based, image-based, and interaction-based classifiers using a fusion method. For example, the server may compute a weighted sum of probability vectors, where weights reflect modality reliability. The resulting combined probability vector represents an estimated emotional state. The server converts this into an analysis result, which includes a dominant emotional category and an associated confidence level.

The server provides the analysis result as an additional condition appended to the prompt sentence or evaluation prompt sentence in the form of control tokens or explicit textual instructions. For example, the server can prepend a descriptor such as “The user appears to be anxious; respond in a reassuring and concise manner.” to the prompt sentence. In some embodiments, the server uses special tokens that generative AI models have been fine-tuned to interpret as instruction markers for style and tone. Because the emotional state is integrated at the prompt construction stage, the internal reasoning and lexical choice patterns of the generative AI models are influenced by the user's emotional context, rather than only modifying the surface form after generation.

This architecture yields a technical improvement over conventional systems. By coordinating multiple generative AI models via explicit evaluation prompt sentences, structured scoring, and numerical aggregation, the server reduces the likelihood of selecting a low-quality response. The cross-evaluation step functions as a distributed error-detection and correction mechanism, in which different models, each trained on different corpora and parameterizations, act as independent reviewers of one another. The server's aggregation algorithms exploit this diversity to improve accuracy and robustness. Compared with a naive single-model system, the server can achieve higher response reliability at similar or lower inference cost, because the system can dynamically choose a smaller integrated response rather than blindly relying on a single large model.

Further, the use of structured numerical scores and aggregation reduces communication overhead between the server and model services. Instead of transmitting large amounts of post-hoc diagnostic data, the server enforces compact, machine-readable scores that can be processed efficiently. The parallel dispatch and asynchronous collection of model responses and evaluations allow the server to overlap network latency and computation, improving response time from the user's perspective. The server can also terminate lagging model calls once sufficient evaluation information has been obtained, thereby conserving network and computation resources.

The integration of emotional state analysis into the evaluation and generation pipeline provides additional technical benefits. By feeding emotion-derived conditions into the generative AI models before generation and evaluation, the server steers the models towards responses that match the user's cognitive load and affective state. This reduces the need for repeated clarifications and follow-up queries, which in turn reduces overall data traffic and computation cycles per resolved user query. The emotional state analysis pipeline itself is implemented with dedicated classifiers, feature extraction circuits, and fusion algorithms that yield a quantitative representation of the user's state, which is then re-used across multiple turns in a dialog, further amortizing computational cost.

The server's internal data structures and processing order are specifically designed to support these improvements. In one variant, the server maintains, for each request identifier, a state object that includes fields for the prompt sentence, attribute information, candidate response identifiers, evaluation matrices, comprehensive scores, emotional state vectors, and final response metadata. The server modules update this state object in place as the request progresses through model invocation, evaluation, aggregation, and integration phases. This structured state representation enables deterministic replay and debugging, enhances cache efficiency in memory, and facilitates incremental refinement of candidate responses without re-executing all processing steps.

In another embodiment, the server can dynamically adjust which generative AI models participate in evaluation or integration based on historical performance metrics stored in the storage apparatus. For example, if a particular model's scores are frequently outliers relative to other models, the server may reduce its weight or temporarily exclude it from evaluation. The server may also adapt sampling parameters such as temperature and top-k values in generation to favor more deterministic outputs in contexts where consistency is critical. Such dynamic control over model participation and parameters constitutes a technical strategy for maintaining performance stability under changing workload and model behavior.

The terminal may also perform part of the processing in some embodiments. For example, the terminal may pre-process voice or image data to extract compressed features before transmitting them to the server, thereby reducing network bandwidth usage and latency. The terminal can also locally cache recent responses and emotional state indications, enabling quicker interface updates and partial offline functionality while still relying on the server for core model orchestration and evaluation computation.

The user benefits from this system by receiving responses that are not only more factually reliable and internally consistent but also adapted in tone and level of detail to the user's emotional state. However, the technical contribution lies in the design of the server-side orchestration algorithms, cross-evaluation mechanisms, emotional state integration pipeline, and the associated data structures, which together improve the operation of the computer system as a whole. The system thus transcends mere automation of human review and manual tone adjustment and provides a non-conventional, computer-centric solution that improves response quality, processing efficiency, and resource utilization in dialog systems built on generative AI models.

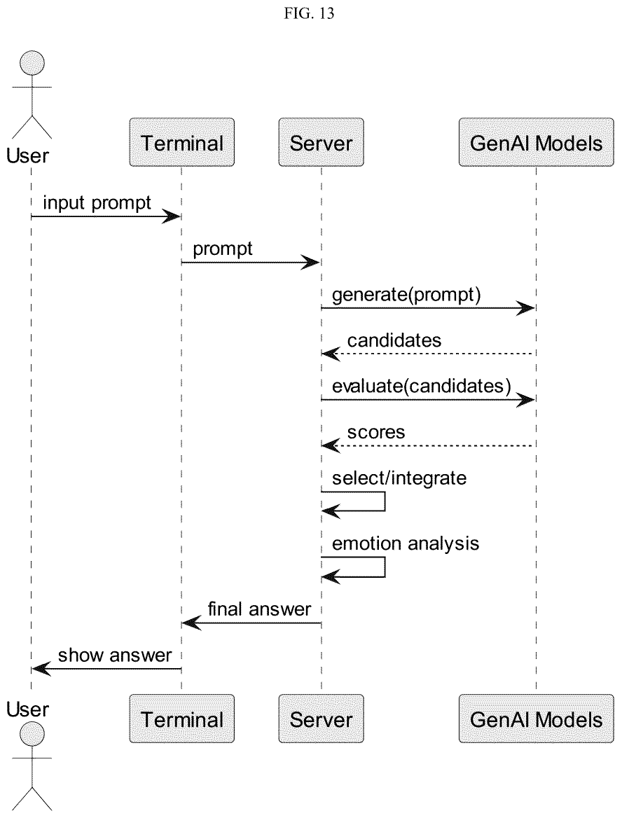

The following describes the processing flow using FIG. 13.

### Step 1

The user operates the terminal and inputs a prompt sentence.

The terminal receives, as input, user manipulation events on a text input field and optional voice or image capture signals. The terminal converts key presses into a character string, performs basic validation such as checking that the string is non-empty and within a maximum length, and designates this string as the prompt sentence. The terminal may also attach attribute information such as a session identifier, language setting, and device type. As output, the terminal generates a structured request message that includes the prompt sentence and the attribute information, and the terminal transmits this request message to the server over a network using a secure communication protocol.

### Step 2

The server receives the request message and stores request information.

The server takes as input the structured request message transmitted from the terminal. The server parses the message to extract the prompt sentence, attribute information, and metadata such as timestamps and network identifiers. The server performs data validation, including checking for prohibited content and proper encoding. The server then writes these values into data records in a storage apparatus, associating them with a newly generated request identifier. As output, the server produces an internal request record that contains the prompt sentence and attribute information, and the server makes this record available for subsequent processing modules.

### Step 3

The server dispatches the prompt sentence to a plurality of generative AI models.

The server receives, as input, the registered request record that includes the prompt sentence. The server looks up a configuration list of available generative AI models and constructs a generation task for each model. The server encapsulates the prompt sentence and optional control parameters (such as maximum token count and sampling temperature) into model-specific API requests. The server then transmits these requests in parallel to the respective generative AI models using asynchronous network calls. Each generative AI model performs neural network inference and returns a generated text sequence. As output, the server obtains a set of candidate response pieces, each associated with a model identifier, and the server stores these candidate response pieces in a candidate response data structure linked to the request identifier.

### Step 4

The server normalizes candidate response pieces and prepares them for evaluation.

The server receives, as input, the raw candidate response pieces generated by the plurality of generative AI models. The server applies normalization operations to each piece, including trimming whitespace, unifying line endings, converting character encodings to a standard format, and optionally filtering or masking disallowed expressions based on predefined rules. The server then converts these normalized texts into internal objects that include fields for the model identifier, normalized text, and placeholder fields for evaluation information. As output, the server produces a list of normalized candidate response objects that are stored in memory and are ready to be embedded into evaluation prompt sentences.

### Step 5

The server constructs evaluation prompt sentences for cross-evaluation.

The server takes as input the list of normalized candidate response objects and the original prompt sentence. For each candidate response object, the server generates one or more evaluation prompt sentences by inserting the original prompt sentence, the candidate response text, and explicit evaluation instructions into a predetermined evaluation template. The server also encodes formatting constraints and required output structure, such as specifying that scores for validity, consistency, and clarity must be given as numerical values. The server may construct multiple evaluation prompt sentences so that different generative AI models evaluate different candidate responses. As output, the server obtains a set of evaluation prompt sentences, each associated with a target generative AI model and a target candidate response identifier.

### Step 6

The server transmits evaluation prompt sentences to generative AI models and acquires evaluation information.

The server receives, as input, the set of evaluation prompt sentences and the mapping between evaluators and target candidate responses. The server sends each evaluation prompt sentence to the designated generative AI model using a model API, in parallel where possible. Each generative AI model performs tokenization, transformer-based encoding and decoding, and outputs a text sequence that includes numerical scores and a comment according to the instructions. The server collects these outputs and parses them using a deterministic parser to extract numerical values for validity, consistency, clarity, and overall quality, as well as free-text comments. As output, the server generates evaluation information records, each linked to a specific candidate response and evaluator model, and stores these records in an evaluation information table or in-memory structure.

### Step 7

The server aggregates numerical scores to compute comprehensive evaluation scores.

The server takes as input all evaluation information records associated with each candidate response. For each candidate response, the server extracts the numerical scores from multiple evaluators and arranges them into a score vector. The server performs data processing that includes calculating statistical measures such as an arithmetic mean, a trimmed mean excluding outliers, or a weighted average using preconfigured model weights. The server may also compute additional metrics such as variance to detect instability. As output, the server assigns a comprehensive evaluation score to each candidate response object and updates the candidate response data structure so that each candidate response is associated with its comprehensive evaluation score.

### Step 8

The server selects and optionally integrates high-scoring candidate responses.

The server receives, as input, the set of candidate responses with their respective comprehensive evaluation scores. The server compares these scores, ranks the candidate responses, and determines whether multiple candidate responses satisfy a predetermined selection condition, such as exceeding a threshold or lying within a specified margin of the highest score. If only one candidate response meets the condition, the server designates that candidate response as the final response piece. If multiple candidate responses meet the condition, the server constructs an integration prompt sentence by concatenating the original prompt sentence with the texts of the high-scoring candidate responses and including explicit instructions for synthesis, conflict resolution, and redundancy reduction. The server sends this integration prompt sentence to a selected generative AI model, receives integrated response information as output, and designates this integrated response information as the final response piece. As output, the server produces a finalized response text associated with the request identifier.

### Step 9

The server analyzes the user's emotional state and adjusts conditions for generation and evaluation.

The server takes as input multimodal signals related to the user, which may include voice information, image information, and operation history information transmitted from the terminal. The server executes data processing pipelines such as extracting audio features from voice signals, extracting visual features from image frames, and computing interaction statistics from operation logs. The server then feeds these features into one or more trained classifiers to infer an emotional state distribution and determines a dominant emotional state and confidence level as an analysis result. Based on this analysis result, the server generates additional condition data, such as tone control tokens or textual instructions about style and level of detail. The server appends these additional conditions to subsequent prompt sentences and evaluation prompt sentences to be sent to generative AI models. As output, the server obtains emotion-aware prompts that influence future generation and evaluation so that they reflect the user's current emotional state.

### Step 10

The server delivers the final response piece to the terminal and the terminal presents it to the user.

The server receives, as input, the final response piece and any associated style adjustments derived from the emotional state analysis. The server encapsulates the final response text and optional metadata (such as indication that multiple generative AI models contributed) into a response message. The server transmits this response message to the terminal through the established network connection. The terminal receives the message, parses the content, and renders the final response text in the user interface, for example as a chat bubble or text area. The terminal may also adapt visual presentation, such as font size or highlighting, based on metadata. As output, the terminal displays the final response to the user, and the user can read the response and decide whether to input a new prompt sentence, thus initiating another iteration through the processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog systems that utilize a single generative AI model typically generate a response directly from a user input without any structured cross-evaluation or emotion-aware control. As a result, such systems often produce responses whose quality in terms of validity, consistency, clarity, accuracy, relevance, reliability, or empathy is highly variable and difficult to predict. From a computer-technology perspective, the response generation pipeline is essentially a single-pass transformation that does not exploit model diversity, internal self-critique, or user-state feedback to improve the computational behavior of the system.

Furthermore, existing systems generally lack an architecture in which multiple generative AI models are orchestrated in parallel as cooperating computing resources. There is no standardized mechanism by which one generative AI model can systematically evaluate the output of another model according to formalized evaluation indices, convert those qualitative judgments into numerical evaluation values, and feed those values into a deterministic selection algorithm. Consequently, the underlying information processing apparatus does not fully utilize available compute resources to improve robustness, nor does it provide a reproducible, machine-controlled procedure for ranking and selecting candidate outputs. A

dditionally, known dialog engines rarely incorporate fine-grained, real-time emotion analysis as a first-class control signal in their computation. Even where sentiment analysis is performed, it is often used only to adjust wording heuristically at the user-interface layer, without integrating emotion data into the internal scoring and selection logic of the response-generation pipeline. Thus, the system's core algorithms do not adapt their weighting of evaluation indices or rewriting behavior in a principled way based on the user's emotional state.

This leads to several technical problems: computational resources of multiple generative models are underutilized; the response selection process lacks a structured, multi-metric scoring mechanism; the system cannot reliably converge to a high-quality answer when different models disagree; and the internal data flow is not configured to use emotion data as a control parameter to adjust evaluation weights and trigger emotion-adapted rewriting. Accordingly, there is a need for an improved information processing system that technically enhances the response-generation pipeline itself by coordinating multiple generative AI models, by converting their internal evaluations into machine-usable scores, and by using emotion data as an input signal to control the ranking and rewriting of candidate outputs, thereby improving the consistency, controllability, and overall performance of the computer-implemented dialog process.

The specific processing by the specific processing unit 290 of the data processing device 12 in Application Example 2 is realized by the following means.

The present invention provides a server comprising a processor configured to generate, based on analysis of input information received from a user terminal, a prompt sentence that specifies processing contents and an output style to be executed by a plurality of generative AI models; to input the prompt sentence in parallel to the plurality of generative AI models and collect, as a group of candidates, a plurality of candidate output pieces of information generated by the plurality of generative AI models; to generate, for each candidate output piece of information, an evaluation prompt sentence that describes an evaluation task, to input the evaluation prompt sentence together with the candidate output piece of information to at least one generative AI model, and to obtain numerical evaluation values for a plurality of evaluation indices including at least one of validity, consistency, clarity, accuracy, relevance, reliability, and empathy; to calculate a comprehensive evaluation score for each candidate output piece of information based on the numerical evaluation values and select at least one optimal candidate output piece of information from the group of candidates based on the comprehensive evaluation scores; to perform, by the processor or the user terminal, emotion analysis processing on user information including at least one of audio information, image information, and text information, and to generate emotion data indicating an emotional state of a user; to apply the emotion data as an additional condition to at least one of the prompt sentence and the evaluation prompt sentence, or to reflect the emotion data in weighting of the comprehensive evaluation scores, thereby adjusting evaluation and selection of the candidate output pieces of information in accordance with the emotional state of the user; to generate a transformation prompt sentence for rewriting the selected optimal candidate output piece of information into a writing style and expression adapted to the emotion data, to input the transformation prompt sentence together with the selected optimal candidate output piece of information to at least one generative AI model, and to generate final answer information that takes emotional suitability into account; and to transmit the final answer information to the user terminal and cause the user terminal to present the final answer information. This enables the computer system to technically improve the response-generation pipeline by orchestrating multiple generative AI models in parallel, converting their qualitative evaluations into structured numerical scores, dynamically adjusting evaluation weights based on emotion data, and performing emotion-aware rewriting under explicit prompt control, thereby enhancing the determinism, robustness, and user-state adaptiveness of the overall information processing.

The term “system” refers to an information processing arrangement including at least one server, at least one processor, and at least one user terminal, which cooperate to execute the functions described in the claims.

The term “processor” refers to a hardware-based arithmetic and logic unit, such as a central processing unit or a processing core, and associated control circuitry that executes machine-readable instructions to perform the described information processing.

The term “user terminal” refers to an information processing device operated by a user, such as a computing device with an input interface and an output interface, capable of communicating with the server and presenting information to the user.

The term “input information” refers to digital data received from the user terminal, including at least text data, and optionally including metadata, which expresses a user's request, question, command, or other instruction.

The term “type of request” refers to a classification result indicating a category of processing to be performed, such as information provision, recommendation, explanation, summarization, or creative generation.

The term “user attributes” refers to information associated with a user, such as preference data, usage history, profile data, or contextual information, which can be used to customize processing and output.

The term “prompt sentence” refers to a text string provided as input to a generative AI model, which specifies processing contents, constraints, roles, or output style to guide the generation of output information by the model.

The term “generative AI model” refers to a machine-learned model that, given an input sequence such as a prompt sentence, generates new data such as natural language text by predicting output tokens using a statistical or neural network architecture.

The term “processing contents” refers to the specific computational task to be executed by a generative AI model, such as answering a question, generating a summary, recommending items, or rewriting text.

The term “output style” refers to a set of constraints or characteristics applied to generated information, such as tone, formality level, length, structure, or point of view.

The term “group of candidates” refers to a collection of multiple candidate output pieces of information, each generated independently by one of a plurality of generative AI models in response to a common or related prompt sentence.

The term “candidate output piece of information” refers to an individual generated output, such as a sentence, paragraph, or document, produced by a generative AI model in response to a prompt sentence.

The term “evaluation prompt sentence” refers to a prompt sentence that instructs a generative AI model to evaluate a candidate output piece of information according to one or more evaluation indices and to output evaluation results.

The term “evaluation task” refers to a computational operation in which a generative AI model analyzes a candidate output piece of information and produces one or more evaluation values or judgments regarding predetermined criteria.

The term “evaluation index” refers to a criterion used to measure the quality or property of a candidate output piece of information, including at least one of validity, consistency, clarity, accuracy, relevance, reliability, and empathy.

The term “validity” refers to a degree to which a candidate output piece of information is logically sound and appropriate in view of the prompt sentence and context.

The term “consistency” refers to a degree to which a candidate output piece of information is free from internal contradictions and maintains a coherent line of reasoning or description.

The term “clarity” refers to a degree to which a candidate output piece of information is easy to understand, unambiguous, and clearly expressed to a typical reader.

The term “accuracy” refers to a degree to which factual statements in a candidate output piece of information correspond to correct information according to a reference or assumed ground truth.

The term “relevance” refers to a degree to which a candidate output piece of information is pertinent to the user's input information, prompt sentence, or intended topic.

The term “reliability” refers to a degree to which a candidate output piece of information can be trusted as dependable, including consideration of coherence, professional tone, and apparent evidential support.

The term “empathy” refers to a degree to which a candidate output piece of information exhibits understanding of, and sensitivity to, a user's emotional state or situation.

The term “numerical evaluation value” refers to a quantitative score, typically represented as a number within a predetermined range, that expresses an evaluation result for a candidate output piece of information with respect to a given evaluation index.

The term “comprehensive evaluation score” refers to an aggregated score computed for a candidate output piece of information by combining a plurality of numerical evaluation values, optionally using weighting coefficients.

The term “optimal candidate output piece of information” refers to at least one candidate output piece of information selected from the group of candidates based on a comparison of comprehensive evaluation scores and optional additional conditions.

The term “user information” refers to data related to a user obtained by the system, including at least one of audio data, image data, and text data, which can be used for emotion analysis.

The term “audio information” refers to digital audio data representing sounds such as a user's speech or vocal expressions acquired by a sound input device.

The term “image information” refers to digital image or video data representing visual content such as a user's facial expression or posture acquired by an image input device.

The term “text information” refers to digital textual data representing user-provided characters, words, or sentences, such as typed input or transcribed speech.

The term “emotion analysis processing” refers to a computational procedure that analyzes user information to infer an emotional state of the user, using pattern recognition, machine learning, or rule-based techniques.

The term “emotion data” refers to data representing an inferred emotional state of a user, including at least one of an emotion label, an intensity score, and a distribution over multiple emotion categories.

The term “emotional state of a user” refers to a psychological or affective condition of the user, such as happiness, sadness, anger, frustration, calmness, or stress.

The term “additional condition” refers to control information, such as emotion data or contextual constraints, that is appended to or embedded in a prompt sentence or evaluation prompt sentence to influence generative or evaluative processing.

The term “weighting of the comprehensive evaluation scores” refers to a process of applying one or more weighting coefficients to numerical evaluation values or aggregated scores to emphasize or attenuate their contribution in selecting a candidate output piece of information.

The term “transformation prompt sentence” refers to a prompt sentence that instructs a generative AI model to rewrite or transform an existing candidate output piece of information according to specified style, tone, or content constraints.

The term “writing style and expression adapted to the emotion data” refers to linguistic characteristics of generated text, such as tone, politeness level, and emotional coloring, selected to be appropriate to the emotional state indicated by the emotion data.

The term “final answer information” refers to output information obtained after selection and, where applicable, rewriting of a candidate output piece of information, which is intended to be presented to the user as a response of the system.

The term “present” refers to the act of outputting or displaying information to a user via a user interface of the user terminal, such as by visual display or audio reproduction.

In one embodiment, a server implements the claimed system as a network-accessible information processing apparatus. The server includes at least one processor, a main memory, a non-transitory storage device, and a network interface. The server executes an operating system such as a general-purpose server operating system, and a middleware stack including a web application framework such as a HTTP server and a scripting language runtime. The server further executes an application program that implements a pipeline for orchestrating a plurality of generative AI models based on prompt sentences, evaluation prompt sentences, and emotion data.

A server uses the main memory to store executable modules including a request-analysis module, a prompt-generation module, a model-orchestration module, an evaluation-control module, an emotion-analysis interface module, a scoring and selection module, and a rewriting-control module. The server stores configuration data in the non-transitory storage device, including a model registry specifying endpoints and capabilities of multiple generative AI models, a definition of evaluation indices, and weighting rules that depend on emotion data.

A terminal functions as a user interface device. The terminal includes at least one input unit such as a keyboard, a touch screen, a microphone, and a camera, and at least one output unit such as a display and a loudspeaker. The terminal executes a client application or a web browser that communicates with the server over a communication network using a protocol such as HTTPS. The terminal acquires user information including text information, audio information, and image information, transmits the user information to the server, and presents final answer information received from the server to a user.

A user interacts with the system by operating the terminal. The user inputs a request in natural language, which may be a question, a command, or a direct prompt sentence for a generative AI model. The user may also allow the terminal to capture audio and image data, such as voice and facial expressions, during the interaction.

In one concrete configuration, a server employs several transformer-based generative AI models as generative AI models. Each generative AI model is implemented as a deep neural network with a multi-layer self-attention architecture, including an embedding layer, a plurality of transformer blocks with self-attention and feed-forward sublayers, and an output projection layer over a token vocabulary. A server stores, in association with each model, parameters such as a number of layers, a number of attention heads, a hidden dimension, and a vocabulary size. A server also stores hyperparameters used during inference, including a temperature parameter for sampling, a maximum output token length, and a top-k or top-p sampling threshold.

A server configures one or more generative AI models as evaluator models that perform evaluation tasks. An evaluator model shares a transformer architecture with a generative model but is used in an evaluation mode in which an input sequence includes both an evaluation prompt sentence and a candidate output piece of information, and the output sequence is constrained to a structured pattern describing numerical evaluation values for specified evaluation indices. For example, an evaluator model may output a fixed-format string encoding numbers between 0 and 100 for indices such as validity, consistency, clarity, accuracy, relevance, reliability, and empathy.

A server uses the request-analysis module to parse input information from the terminal. The request-analysis module utilizes a natural language processing library, which executes tokenization, part-of-speech tagging, and semantic classification algorithms on the input text. The server builds a feature vector from the input text, including token embeddings, positional information, n-gram statistics, and optionally user attributes retrieved from a user profile database. A server uses these feature vectors as input to an intent classification model implemented as a neural network, which has been trained with supervised learning using a cross-entropy loss function and gradient-based optimization. The intent classification model outputs a distribution over possible request types, such as question answering, recommendation, explanation, or creative generation.

A server employs the prompt-generation module to construct a prompt sentence based on the classified intent, the extracted keywords, and user attributes. The prompt-generation module uses a template library in which each template specifies a role, a task description, constraints on length and style, and mention of evaluation criteria. The module fills template variables with context-specific information, such as a requested domain or content category. Example prompt sentences used by the server include:
“You are a movie recommendation assistant. Given the user's interest in action movies, generate three short movie descriptions (60-80 words each). Focus on validity, consistency, and clarity.”
“Evaluate the following answer on a 0 -100 scale for validity, consistency, and clarity. Return the scores in a single line of text in the order: validity, consistency, clarity, total. Answer: [candidate text].”
“The user is frustrated. Rewrite the following answer in a calm, empathetic, and clear tone, without changing the meaning: [candidate text].”
“The user's emotion is ‘sad’. Propose three content recommendations that are likely to improve the user's mood, and explain briefly why each recommendation may help.”

A server uses the model-orchestration module to coordinate multiple generative AI models in parallel. The server maintains a model registry, which is a data structure stored in the non-transitory storage device and loaded into memory, describing each model's identifier, endpoint URL or local execution interface, expected latency, domain specialization, and cost. The model-orchestration module applies a selection policy that chooses a subset of models for each request, depending on the intent classification and user attributes. For example, for a technical question, the selection policy may assign a higher probability to models specialized in technical documentation.

A server issues, for each selected model, a prompt sentence and control parameters. When a model is deployed as an external network service, the server transmits the prompt sentence and parameters via a network interface using a structured protocol. When a model is deployed locally on the same hardware, the server passes tokenized representations of the prompt sentence directly to a model inference engine. The server uses asynchronous input/output mechanisms so that forward passes through different generative AI models proceed in parallel. This parallel orchestration improves throughput and reduces latency relative to a sequential invocation scheme.

A server obtains, from each generative AI model, at least one candidate output piece of information. The server converts model outputs, which are sequences of token indices, into text strings using a deterministic tokenizer. The server associates each text string with metadata including the model identifier, sampling parameters, and the time required for generation. The group of candidates is represented as an array or list of objects containing text fields and associated numerical attributes. This explicit data structure allows the evaluation-control module to access and process candidate outputs in a consistent manner.

A server uses the evaluation-control module to generate evaluation prompt sentences for each candidate output piece of information. For each evaluation index or combination of indices, the module constructs a prompt sentence that describes the evaluation task and prescribes a fixed-format numerical output. The server then forwards each evaluation prompt sentence together with the candidate output piece of information to an evaluator model. The evaluator model processes the combined text using the same transformer architecture and produces an output string containing numerical evaluation values. A server parses the output string using a deterministic parser, converts substrings into numerical values, and stores the numerical evaluation values in a scoring record that is associated with the candidate output piece of information.

A server employs the scoring and selection module to compute comprehensive evaluation scores. The scoring and selection module retrieves numerical evaluation values for each candidate output piece of information for indices such as validity, consistency, clarity, accuracy, relevance, reliability, and empathy. The module applies a weighting vector to these values to produce a weighted sum or another aggregation function, such as a normalized weighted average. The weighting vector itself can depend on static configuration or on the current emotion data. By implementing the scoring as explicit arithmetic on numerical values, the server provides a deterministic decision procedure that differs from ad hoc or heuristic selection and that can be optimized for machine performance.

A terminal or the server executes emotion analysis processing on user information. In one embodiment, the terminal acquires audio information by sampling a microphone with a fixed sampling rate and converts the audio information into a time-frequency representation such as a mel-frequency spectrogram. The terminal applies a convolutional neural network trained on labeled emotional speech data to infer probabilities for emotion categories such as neutral, happy, sad, and angry. Alternatively or additionally, the terminal captures image information using a camera, extracts facial landmarks using a computer vision library, and feeds these features into a neural network classifier trained to recognize facial expressions. The terminal transmits the inferred emotion data to the server as numerical scores.

In another embodiment, the server accepts raw audio or image data from the terminal and performs emotion analysis processing centrally. A server can also execute a textual emotion classifier on text information derived from user input. In that case, the server tokenizes the text and passes the resulting token sequence to a classifier network that has been fine-tuned with a supervised learning method on labeled emotional text. The classifier network outputs a probability distribution over emotion labels, which the server converts into emotion data.

A server uses the emotion-analysis interface module to unify emotion data from different modalities into a common representation. This representation may be a vector of real numbers in which each element corresponds to the intensity of a particular emotion category.

The server stores emotion data together with a timestamp and a session identifier, and can optionally compute a moving average over recent interactions to smooth short-term fluctuations.

A server integrates emotion data into the prompt-generation module and the evaluation-control module. The server inserts, into the prompt sentence or evaluation prompt sentence, explicit textual descriptors of the user's emotional state when appropriate. For example, the server may prepend a clause such as “The user seems anxious. Provide a reassuring explanation.” to a prompt sentence. This integration makes the generative AI models aware of the emotional context and causes them to adjust lexical choice and tone accordingly.

A server further uses emotion data to adjust the weighting vector applied in the scoring and selection module. For example, when the emotion data indicates sadness, the server increases the weight of empathy and clarity and decreases the weight of harsh criticism or negativity. When the emotion data indicates frustration, the server increases the weight of clarity and accuracy and reduces tolerance for ambiguous or evasive content. These modifications are expressed as arithmetic operations on stored weighting coefficients and are thus machine-implemented in a reproducible manner.

A server employs the rewriting-control module to generate transformation prompt sentences. When the scoring and selection module selects an optimal candidate output piece of information based on its comprehensive evaluation score, the rewriting-control module constructs a transformation prompt sentence that instructs a generative AI model to rewrite the selected candidate in a style adapted to the emotion data. The transformation prompt sentence may specify that certain content must be preserved while tone and wording are changed. The server then invokes a generative AI model with the transformation prompt sentence and the selected candidate, and obtains final answer information that has been rewritten. Because the rewriting process is driven by a fixed transformation prompt sentence and uses a probabilistic model with constrained temperature and sampling parameters, the server can systematically generate answers that are both semantically consistent with the selected candidate and adapted to the user's emotional state.

The described architecture improves computer technology in several respects. First, by orchestrating multiple generative AI models in parallel and using explicit numerical evaluation values to select an optimal candidate, the server converts a non-deterministic single-model behavior into a multi-step computation that yields improved stability and quality. This reduces error rates and variance in generated responses. Second, by structuring evaluation as a separate step driven by evaluation prompt sentences and by aggregating numerical scores using adjustable weights, the server enables fine-grained, machine-controlled optimization of response quality along multiple dimensions, which is not achievable by conventional one-pass generation pipelines.

Third, by integrating emotion data into both the evaluation weighting and the rewriting-control stages, the server uses emotion data as a control signal that directly influences internal scoring computations and text transformation behavior. This integration improves the match between system outputs and user state without merely changing presentation-layer formatting. The emotion-dependent weighting also allows the system to focus computational resources on candidate outputs that are more suitable in the current context, thereby reducing the number of iterations or corrections needed and improving overall computational efficiency.

Fourth, by employing explicit data structures for the group of candidates, the numerical evaluation values, the weighting vectors, and the emotion data, the system achieves improved data management and traceability. A server can log these structures and reuse them for further learning or optimization, enhancing retrainability of the underlying neural networks. For example, the server can use pairs of input information and selected final answer information as training examples for fine-tuning generative AI models with loss functions such as cross-entropy or reinforcement-learning-based objective functions that reward alignment with high evaluation scores.

In one alternative embodiment, a server deploys some generative AI models on separate physical devices or accelerator units such as graphical processors. The model-orchestration module assigns models to hardware resources based on load and specialization. This arrangement reduces contention on a single processor and allows the system to maintain responsiveness even under high user concurrency.

In another alternative embodiment, a terminal is implemented as a wearable device such as smart glasses, and the server generates answers that are optimized for short-form display. In this case, prompt sentences explicitly constrain length and output format so that generated text fits within a limited display area. The emotion analysis processing takes into account not only the user's emotional state but also environmental audio and image conditions, thereby providing context that further refines weighting rules.

In yet another embodiment, a server uses additional evaluation indices, such as safety and compliance, and incorporates external rule-based filters that examine candidate outputs for prohibited content according to predetermined policies. These filters operate on tokenized text and apply pattern matching and classification algorithms. The scoring and selection module then assigns a very low or zero comprehensive evaluation score to candidates that violate safety criteria.

Across these embodiments, the server executes specific algorithms and data flows that go beyond merely automating human judgment. The system defines a layered structure in which generation, evaluation, scoring, emotion integration, and rewriting are implemented as distinct computational stages with well-defined interfaces and data structures. This layered design, together with the explicit use of numerical evaluation values and weighting vectors, improves determinism, robustness, and adaptability of computer-implemented dialog processing, thereby providing a concrete technological improvement over conventional single-model, single-pass response generation systems.

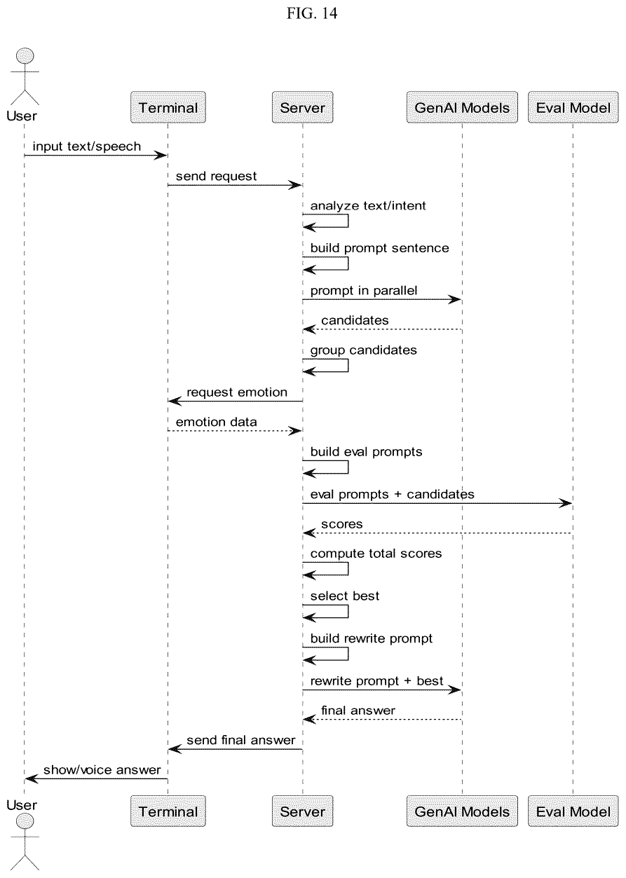

The following describes the processing flow using FIG. 14.

### Step 1

User provides input to terminal.

User operates the terminal and inputs a natural-language request as text, such as “Recommend an action movie and give a short review,” or speaks a request that is captured by a microphone.

Input: User speech or typed text.

Output: Raw user input data stored in the terminal (audio waveform and/or text string).

### Step 2

Terminal acquires user information and transmits it to server.

Terminal converts audio to text using a speech-to-text engine, and optionally captures image frames from a camera for facial analysis. Terminal packages the text, and optionally audio-derived features, image-derived features, and device metadata into a request message and sends it to the server over a network.

Input: Raw user input data (audio, text, and optionally image), device metadata. Output: Network request containing user text information, and optionally audio and image information, delivered to the server.

### Step 3

Server receives and stores the request.

Server accepts the request via a network interface, verifies message integrity and authentication, and writes a log entry to persistent storage. Server extracts the text information and any attached emotion-related features from the message.

Input: Network request from terminal.

Output: Parsed request object in memory containing user text, optional auxiliary features, and a session identifier.

### Step 4

Server performs linguistic analysis and intent classification.

Server uses a natural language processing module to tokenize the user text, perform part-of-speech tagging, and extract keywords. Server then feeds token embeddings into a trained intent classification model and computes a probability distribution over possible request types, selecting the most probable type as the intent.

Input: User text string.

Output: Intent label (for example, “recommendation” or “question answering”), keyword list, and feature vector representing the input.

### Step 5

Server retrieves user attributes and context.

Server queries a user profile database using the session identifier and user identifier, and retrieves historical preference data, past interactions, and language settings. Server combines these attributes with the feature vector from Step 4 to build a contextual state for this request.

Input: Session identifier, user identifier, feature vector, keyword list.

Output: Context object containing user attributes, intent, keywords, and derived context features.

### Step 6

Server generates a primary prompt sentence for generative AI models.

Server selects a prompt template based on the intent and context, and fills template slots with domain-specific terms and constraints. Server constructs a complete prompt sentence, such as: “You are a movie recommendation assistant. Given the user's interest in action movies, generate three short movie descriptions (60-80 words each). Focus on validity, consistency, and clarity.”

Input: Context object (intent, keywords, user attributes).

Output: Primary prompt sentence text to be sent to multiple generative AI models.

### Step 7

Server selects a set of generative AI models to invoke.

Server accesses a model registry that lists available generative AI models and their capabilities, and applies a selection policy that takes into account the intent, domain, and current server load. Server chooses, for example, two or more generative models to generate diverse candidate outputs.

Input: Context object and model registry.

Output: List of selected generative AI model identifiers and associated invocation parameters.

### Step 8

Server dispatches the prompt sentence to multiple generative AI models in parallel.

Server constructs inference requests for each selected model, containing the prompt sentence and parameters such as maximum token length and sampling temperature. Server sends these requests concurrently, either to local inference engines or to remote model endpoints via asynchronous network calls.

Input: Primary prompt sentence, selected model list, and model parameters.

Output: A set of pending inference tasks associated with each generative AI model.

### Step 9

Generative AI models generate candidate output pieces of information.

Each generative AI model receives the prompt sentence and performs a forward pass through its neural network, iteratively predicting output tokens until a termination condition is met. Each model returns a sequence of tokens that the server decodes into a text string representing a candidate output piece of information.

Input: Prompt sentence and model parameters.

Output: Candidate text outputs, each tagged with the generating model's identifier.

### Step 10

Server collects and structures the group of candidates.

Server waits for all model responses or until timeouts occur, then aggregates the resulting candidate texts into a list or array. Server attaches metadata, such as generation time and inference configuration, to each candidate.

Input: Candidate text outputs from generative AI models.

Output: Group of candidates represented as structured records containing candidate texts and metadata.

### Step 11

Terminal or server acquires additional user emotion information.

Terminal may capture audio and image data during the interaction and compute emotion features using local models, or the server may request raw or preprocessed features. The terminal or server applies an emotion recognition model to infer emotion labels and scores (for example, sadness 0.7, joy 0.2).

Input: Audio waveform, video frames, or text signals associated with the user.

Output: Emotion data containing emotion category probabilities or scores.

### Step 12

Server normalizes and stores emotion data.

Server receives emotion data from the terminal or computes it locally, maps various modalities into a unified representation, and stores it in a session record. Server may compute a smoothed emotion state by combining current emotion scores with past emotion measurements in this session.

Input: Raw or preprocessed emotion data from terminal or internal models.

Output: Normalized emotion vector and a dominant emotion label associated with the current request.

### Step 13

Server generates evaluation prompt sentences for each candidate.

Server uses an evaluation template to build evaluation prompt sentences that instruct an evaluator generative AI model to score each candidate. For each candidate, the server embeds the candidate text into a prompt such as: “Evaluate the following answer on a 0 -100 scale for validity, consistency, and clarity. Return the scores in the order: validity, consistency, clarity, total. Answer: [candidate text].”

Input: Group of candidates, evaluation criteria definitions, emotion label (optional).

Output: Set of evaluation prompt sentences, each linked to a corresponding candidate.

### Step 14

Server invokes evaluator generative AI models with evaluation prompt sentences.

Server selects one or more evaluator models and sends each evaluation prompt sentence, possibly in parallel, to these models. Each evaluator model processes the prompt and emits an output string containing numerical scores for specified indices.

Input: Evaluation prompt sentences and evaluator model identifiers.

Output: Raw evaluation outputs (text with embedded numerical values) for each candidate.

### Step 15

Server parses evaluation outputs and records numerical evaluation values.

Server applies a parser to each evaluator output, extracting numerical values corresponding to validity, consistency, clarity, and any other indices. Server then stores these numerical evaluation values in association with each candidate in a scoring data structure. Input: Raw evaluation output strings from evaluator models. Output: Numerical evaluation records containing per-index scores for each candidate.

### Step 16

Server computes comprehensive evaluation scores.

Server retrieves the index-specific scores for each candidate and applies weighting coefficients, which may depend on static configuration and the current emotion vector. Server calculates a comprehensive evaluation score, for example as a weighted sum or normalized score, for each candidate.

Input: Numerical evaluation records and weighting coefficients (including emotion-dependent adjustments).

Output: Comprehensive evaluation score for each candidate in the group.

### Step 17

Server selects an optimal candidate output piece of information.

Server compares the comprehensive evaluation scores across all candidates and identifies the maximum score. Server chooses the associated candidate as a primary optimal candidate. If multiple candidates have scores within a small range of the maximum, the server may use emotion-specific tie-breaking rules that favor candidates more aligned with the current emotion label.

Input: Comprehensive evaluation scores for all candidates, emotion data.

Output: Selected optimal candidate output piece of information.

### Step 18

Server determines whether emotion-adapted rewriting is required.

Server inspects the emotion data and the characteristics of the selected candidate, such as tone and formality, which may be derived from metadata or additional classification. If the emotion vector suggests a need for a different tone (for example, more empathy in response to frustration), the server decides to perform rewriting.

Input: Selected candidate text, emotion vector, tone analysis of candidate.

Output: Decision flag indicating whether rewriting is needed, plus parameters for desired style.

### Step 19

Server generates a transformation prompt sentence for rewriting.

Server constructs a transformation prompt sentence that specifies the target tone, style, and constraints, incorporating the emotion data. For example, the prompt may be: “The user is frustrated. Rewrite the following answer in a calm, empathetic, and clear tone, without changing the meaning: [candidate text].”

Input: Selected candidate text, desired style parameters, emotion label.

Output: Transformation prompt sentence to be used for rewriting.

### Step 20

Server invokes a generative AI model for rewriting and obtains final answer information.

Server sends the transformation prompt sentence and the selected candidate text to a generative AI model configured for rewriting. The model processes the input and generates a rewritten text that maintains the original content while modifying tone and style.

Input: Transformation prompt sentence and selected candidate text.

Output: Final answer information text adapted to the user's emotional state.

### Step 21

Server performs final validation and formatting.

Server runs basic validation rules on the final answer, such as checking length constraints, ensuring required items are present, and optionally passing the answer through safety and compliance filters. Server then formats the final answer into a response structure suitable for the terminal, which may include additional fields like explanation or recommended items.

Input: Final answer information text and validation rules.

Output: Formatted response object containing final answer information and optional metadata.

### Step 22

Server transmits the final answer information to terminal.

Server serializes the response object into a network message and sends it through the network interface to the terminal. Server may also log the association between the original request, the group of candidates, scores, and the final answer for future training and analysis.

Input: Formatted response object.

Output: Network response delivered to the terminal containing final answer information.

### Step 23

Terminal presents the final answer information to user.

Terminal receives the network response, parses the content, and displays the final answer text on the screen in a chat or recommendation layout. Optionally, the terminal converts the text to speech for audio output. The terminal may also highlight recommendations as clickable elements for further interaction.

Input: Network response with final answer information.

Output: Visual and/or audio presentation of the final answer information to the user.

### Step 24

User evaluates the response and optionally provides feedback.

User reads or listens to the final answer, makes a selection among recommended items, or inputs a follow-up question such as “Show me another option” or “Explain this in simpler terms.” The user's actions generate new input data that the terminal captures and sends back to the server.

Input: Final answer information displayed by the terminal.

Output: New user input (selection, rating, or additional prompt sentence) that can be processed in a new execution of the above steps.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

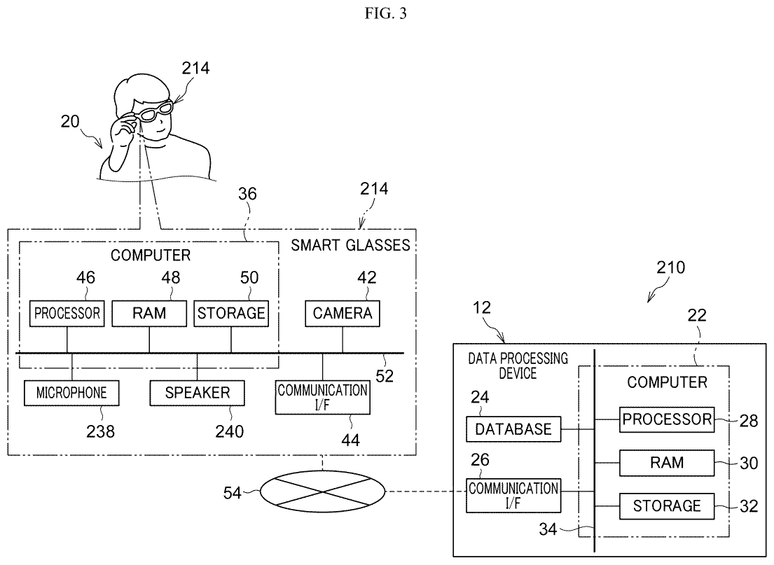

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

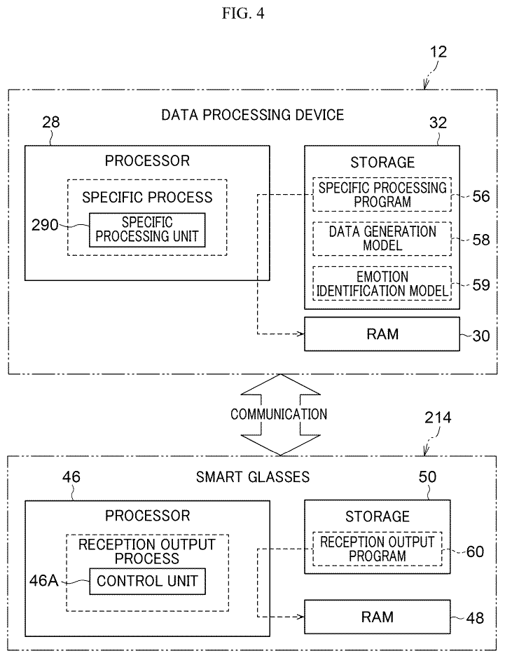

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

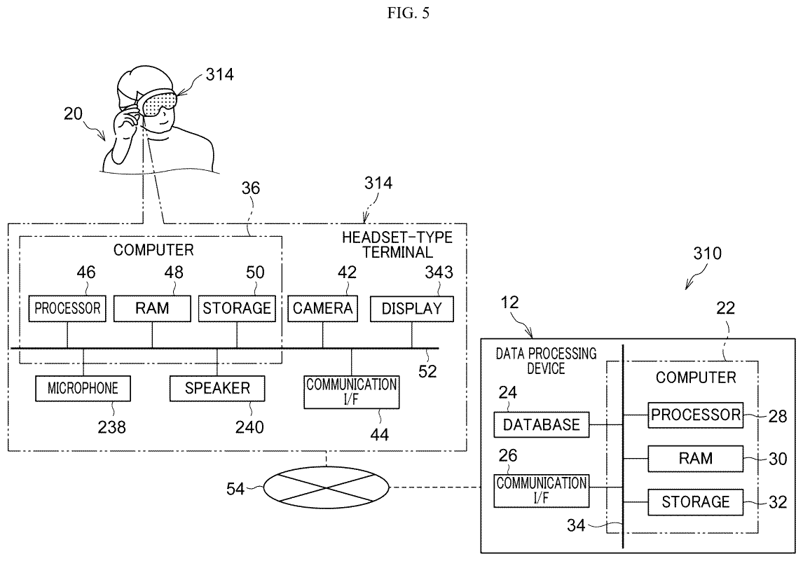

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

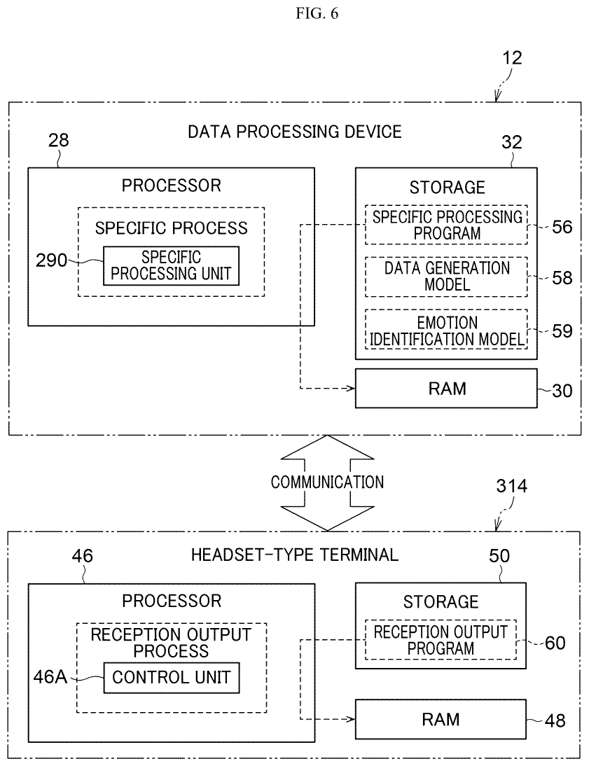

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

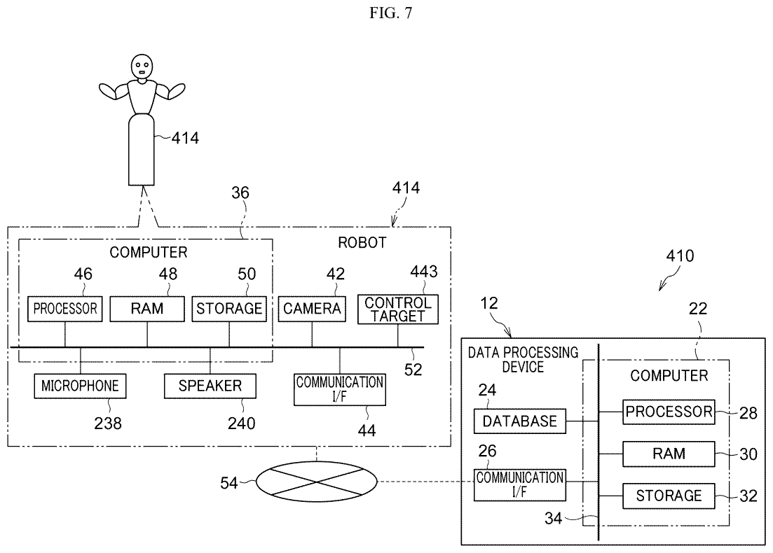

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

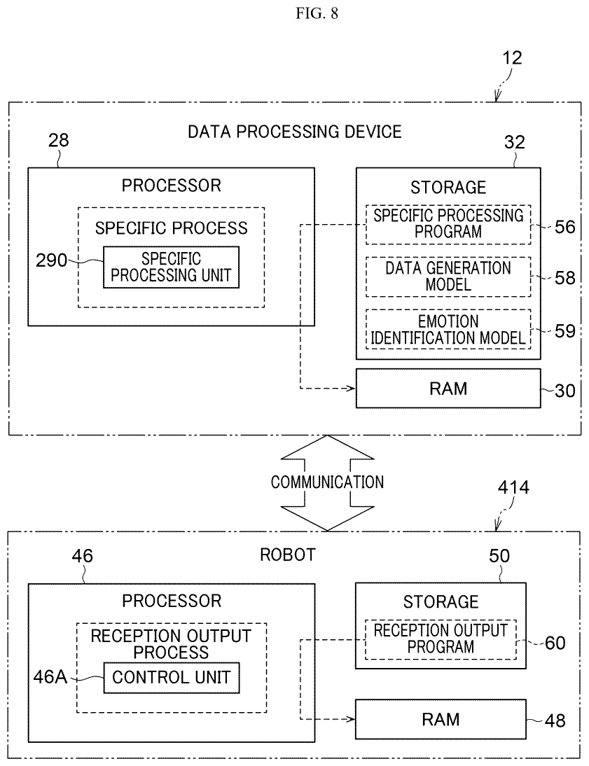

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

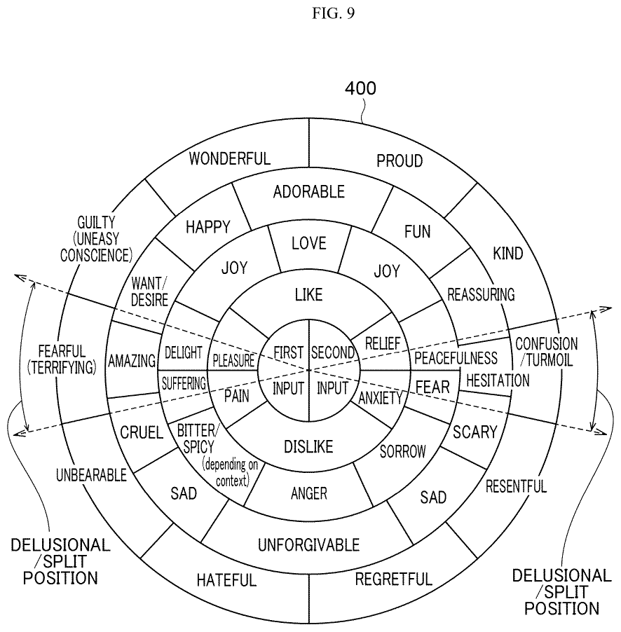

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

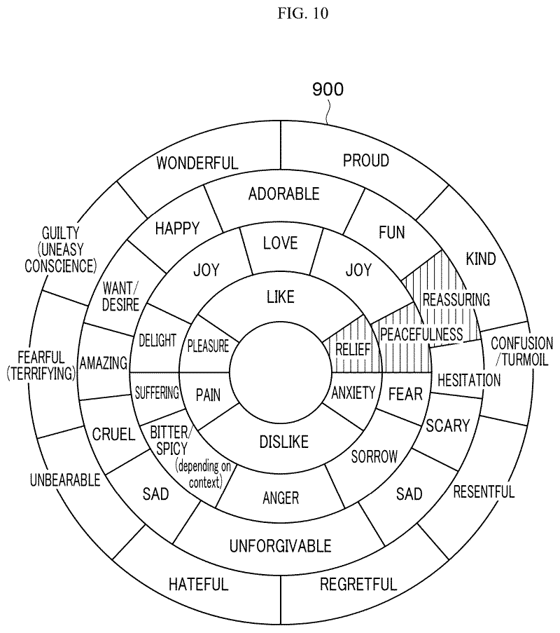

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal, a prompt sentence including an inquiry input by a user via the terminal, and assign the prompt sentence as common input data to a plurality of generative AI models,
execute parallel operation of the plurality of generative AI models and cause the plurality of generative AI models, based on mutually different training data or mutually different parameter settings, to generate a plurality of types of answer information in response to the prompt sentence,
evaluate the plurality of types of answer information by using a separate generative AI model or an evaluation algorithm and calculate evaluation information regarding at least correctness, clarity, and usefulness to the user,
select, based on the evaluation information, at least one piece of final answer information from among the plurality of types of answer information, or integrate the plurality of types of answer information to generate integrated answer information,
transmit, to the terminal, the final answer information or the integrated answer information in association with the plurality of types of answer information, and enable the terminal to display the plurality of types of answer information in a comparable manner and to acquire feedback information based on a selection operation by the user, and
store emotion analysis information indicating an emotional state of the user, the emotion analysis information being transmitted from the terminal, and the feedback information, and update operation conditions of at least one of the plurality of generative AI models or the evaluation algorithm based on the emotion analysis information and the feedback information.

### (Supplementary 2)

The system according to supplementary 1,
wherein the processor is configured to compare the plurality of types of answer information generated by the plurality of generative AI models with one another in the evaluation, to correct the evaluation information by taking into account the emotion analysis information acquired from the terminal and the feedback information based on the selection operation by the user, and to determine the final answer information or the integrated answer information based on the corrected evaluation information.

### (Supplementary 3)

The system according to supplementary 1,
wherein the processor is configured, when selecting the final answer information based on the evaluation information, to extract, as candidate answer information, at least one piece of answer information that satisfies a predetermined condition of an evaluation score, to preferentially select, as the final answer information, candidate answer information that matches the emotional state of the user based on the emotion analysis information, or to integrate the candidate answer information to generate integrated answer information that is most suitable for the emotional state of the user, and to provide the final answer information or the integrated answer information to the terminal.

### Application Example 1

### (Supplementary 1)

A system comprising a processor,
wherein the processor is configured to
receive character string information transmitted from a use terminal, perform natural language analysis on the character string information to extract intention information and feature information, and generate, on the basis of the intention information and the feature information, a plurality of prompt sentences for causing a plurality of generative AI models to operate in mutually different expression styles and mutually different viewpoints,
transmit, by using a parallel processing mechanism, the plurality of prompt sentences to the plurality of generative AI models in parallel, and acquire, from the plurality of generative AI models, a plurality of types of generated information corresponding to the different expression styles and the different viewpoints,
execute, for the plurality of types of generated information, a quality evaluation process by using an evaluation generative AI model and a rule processing mechanism, and calculate evaluation information for each piece of the generated information on the basis of the quality evaluation process, s
elect, on the basis of the evaluation information, at least one of the plurality of types of generated information as final response information, and integrate the plurality of types of generated information to generate integrated response information by executing similarity calculation processing and contradiction detection processing among the plurality of types of generated information to remove duplicate information and contradiction information,
generate response structure data including the final response information and the integrated response information, and transmit the response structure data to the use terminal so that, at the use terminal, information for the different expression styles and the different viewpoints is selectively displayable, and
input, into the evaluation process for the plurality of types of generated information generated by the plurality of generative AI models, an analysis result of an emotional state of a user as input information, and determine the final response information in consideration of the analysis result of the emotional state.

### (Supplementary 2)

The system according to supplementary 1,
wherein the processor is configured to
compare the plurality of types of generated information generated by the plurality of generative AI models with one another to calculate overlap information and difference information, and, on the basis of the overlap information and the difference information,
extract information elements to be included in the integrated response information and construct the integrated response information by applying weighting to information elements that conform to the analysis result of the emotional state of the user.

### (Supplementary 3)

The system according to supplementary 1,
wherein the processor is configured to
generate, in the quality evaluation process, an evaluation prompt sentence that uses each piece of the plurality of types of generated information generated by the plurality of generative AI models as input, input the evaluation prompt sentence to the evaluation generative AI model to obtain evaluation indices relating to accuracy, clarity, and usefulness of each piece of the generated information, and determine the final response information by preferentially selecting at least one of the plurality of generative AI models on the basis of the evaluation indices and the analysis result of the emotional state of the user.

### Example 2

### (Supplementary 1)

A system comprising a processor,
wherein the processor is configured to
receive, from a terminal operated by a user, a prompt sentence and associated attribute information and store the prompt sentence and the associated attribute information as request information in a storage apparatus,
transmit, in parallel, the prompt sentence included in the request information to a plurality of generative artificial intelligence models, acquire a plurality of candidate response pieces generated by the plurality of generative artificial intelligence models based on the prompt sentence, normalize the plurality of candidate response pieces, and temporarily hold the plurality of normalized candidate response pieces,
generate, for each of the plurality of candidate response pieces, an evaluation prompt sentence including an original prompt sentence and the corresponding candidate response piece, transmit the evaluation prompt sentence to the plurality of generative artificial intelligence models, acquire, from the plurality of generative artificial intelligence models,
evaluation information including numerical scores relating to validity, consistency, and clarity and including an evaluation comment, and store the evaluation information in association with each of the plurality of candidate response pieces,
execute, for each of the plurality of candidate response pieces, at least one of a statistical aggregation process and a weighted averaging process on the numerical scores included in a plurality of pieces of evaluation information acquired from the plurality of generative artificial intelligence models to calculate a comprehensive evaluation score, and select at least one final response piece from among the plurality of candidate response pieces based on the comprehensive evaluation score,
generate, when a plurality of candidate response pieces each having a comprehensive evaluation score that satisfies a predetermined condition exist, an integration prompt sentence including the plurality of candidate response pieces and the original prompt sentence,
transmit the integration prompt sentence to a predetermined generative artificial intelligence model, cause the predetermined generative artificial intelligence model to generate integrated response information, and determine the integrated response information as the final response piece,
transmit the final response piece to the terminal and cause the final response piece to be presented in a dialogue with the user, and
analyze an emotional state of the user based on at least one of voice information, image information, and operation history information of the user, provide an analysis result as an additional condition to at least one of the prompt sentence and the evaluation prompt sentence to be supplied to the plurality of generative artificial intelligence models, and optimize the dialogue with the user according to the emotional state of the user.
   (supplementary 2)

The system according to supplementary 1,
wherein the processor is configured to
compare, in evaluation of the plurality of candidate response pieces, evaluation information relating to a candidate response piece generated by one generative artificial intelligence model with evaluation information relating to a candidate response piece generated by another generative artificial intelligence model, and correct the comprehensive evaluation score by applying the analysis result of the emotional state of the user as at least one of a weighting coefficient and a correction coefficient to the numerical scores included in the evaluation information.

### (Supplementary 3)

The system according to supplementary 1,
wherein the processor is configured to
select, in selecting the final response piece, at least one of a candidate response piece and integrated response information having a highest comprehensive evaluation score as a preferred final response piece, generate response information in which at least one of tone, expression density, and presentation format is adjusted based on the analysis result of the emotional state of the user, and provide the response information to the user via the terminal.

### Application Example 2

### (Supplementary 1)

A system comprising a processor,
wherein the processor is configured to
receive input information from a user terminal and analyze the input information to identify a type of request and user attributes, and generate, based on the identified type of request and user attributes, a prompt sentence that specifies processing contents and an output style to be executed by a plurality of generative AI models,
input the prompt sentence in parallel to the plurality of generative AI models and collect, as a group of candidates, a plurality of candidate output pieces of information generated respectively by the plurality of generative AI models,
generate an evaluation prompt sentence that describes an evaluation task for each candidate output piece of information in the group of candidates, and input the evaluation prompt sentence together with each candidate output piece of information to at least one generative AI model to obtain numerical evaluation values for a plurality of evaluation indices including at least one of validity, consistency, clarity, accuracy, relevance, reliability, and empathy, calculate a comprehensive evaluation score for each candidate output piece of information based on the numerical evaluation values, and select at least one optimal candidate output piece of information from the group of candidates based on the comprehensive evaluation scores,
cause the processor or the user terminal to perform emotion analysis processing on user information including at least one of audio information, image information, and text information, and generate emotion data indicating an emotional state of a user,
apply the emotion data as an additional condition to at least one of the prompt sentence and the evaluation prompt sentence, or reflect the emotion data in weighting of the comprehensive evaluation scores, so as to adjust evaluation and selection of the candidate output pieces of information in accordance with the emotional state of the user, generate a transformation prompt sentence for rewriting the selected optimal candidate output
piece of information into a writing style and expression that are adapted to the emotion data, and input the transformation prompt sentence together with the selected optimal candidate output piece of information to at least one generative AI model to generate final answer information that takes emotional suitability into account, and
transmit the final answer information to the user terminal and cause the user terminal to present the final answer information.

### (Supplementary 2)

The system according to supplementary 1,
wherein the processor is configured to
mutually compare the plurality of candidate output pieces of information obtained from the plurality of generative AI models based on the numerical evaluation values, and dynamically change weighting coefficients for the evaluation indices based on the emotion data, thereby emphasizing or attenuating the comprehensive evaluation scores of candidate output pieces of information that are suitable for the emotional state of the user and determining the optimal candidate output piece of information.

### (Supplementary 3)

The system according to supplementary 1,
wherein the processor is configured to
provisionally select, as the optimal candidate output piece of information, a candidate output piece of information having a maximum comprehensive evaluation score, and, when the comprehensive evaluation score of the provisionally selected candidate output piece of information is within a predetermined range relative to comprehensive evaluation scores of other candidate output pieces of information, finally select the final answer information based on a degree of suitability to the emotional state of the user represented by the emotion data.

What is claimed is:

1. A system comprising:
circuitry configured to:
receive, via a communication interface coupled to a packet-switched network, a prompt sentence including an inquiry from a user from a terminal device, and assign the prompt sentence as common input data to a plurality of generative neural network models;
execute parallel operation of the plurality of generative neural network models and acquire a plurality of candidate answer outputs generated respectively by the plurality of generative neural network models based on mutually different parameter settings;
generate an evaluation prompt sentence for each candidate answer output, input the evaluation prompt sentence to at least one generative neural network model, and calculate a comprehensive evaluation score for each candidate answer output based on numerical evaluation values for a plurality of evaluation indices;
select at least one final answer output from among the candidate answer outputs based on the comprehensive evaluation scores;
analyze an emotional state of the user based on user information received from the terminal device, and apply an analysis result of the emotional state to at least one of the evaluation prompt sentence or the comprehensive evaluation scores to adjust selection of the final answer output in accordance with the emotional state; and
transmit the final answer output to the terminal device via the communication interface.

2. The system according to claim 1, wherein the circuitry is configured to generate the evaluation prompt sentence by encoding each candidate answer output together with the original prompt sentence as a combined input sequence, and to obtain numerical evaluation values for evaluation indices comprising at least validity, consistency, and clarity.

3. The system according to claim 2, wherein the circuitry is configured to calculate the comprehensive evaluation score by executing at least one of a statistical aggregation process or a weighted averaging process on the numerical evaluation values, and to dynamically adjust weighting coefficients for the evaluation indices based on the analysis result of the emotional state.

4. The system according to claim 3, wherein the circuitry is configured to provisionally select a candidate answer output having a maximum comprehensive evaluation score, and when the comprehensive evaluation score of the provisionally selected candidate answer output is within a predetermined range relative to scores of other candidates, select the final answer output based on a degree of suitability to the emotional state of the user.

5. The system according to claim 4, wherein the circuitry is configured to generate a transformation prompt sentence for rewriting the selected final answer output into a writing style and expression adapted to the analysis result of the emotional state, and input the transformation prompt sentence together with the selected final answer output to at least one generative neural network model to generate emotion-adapted final answer information.

6. The system according to claim 1, wherein the circuitry is configured to analyze the emotional state by applying an emotion identification model to at least one of audio information, image information, or text information received from the terminal device, and to classify the emotional state into an emotional category.

7. The system according to claim 6, wherein the circuitry is configured to incorporate the emotional category as an additional condition appended to the evaluation prompt sentence, thereby causing the at least one generative neural network model to weight the numerical evaluation values for an empathy evaluation index in accordance with the emotional category.

8. The system according to claim 7, wherein the circuitry is configured to extract acoustic features from audio information received from the terminal device and classify the acoustic features using an acoustic emotion classifier to derive the emotional category, the acoustic features comprising at least one of pitch, energy, or speech rate information.

9. The system according to claim 1, wherein the circuitry is configured to perform natural language analysis on the prompt sentence to extract intention information and feature information, and to generate a plurality of prompt sentences specifying mutually different expression styles and viewpoints for distribution to the plurality of generative neural network models prior to parallel execution.

10. The system according to claim 9, wherein the circuitry is configured to transmit the plurality of prompt sentences to the plurality of generative neural network models using a parallel processing mechanism, and to normalize the plurality of candidate answer outputs acquired from the plurality of generative neural network models prior to evaluation.

11. The system according to claim 1, wherein the circuitry is configured to compare candidate answer outputs generated by different generative neural network models against each other based on the numerical evaluation values, and to update operation conditions of at least one of the plurality of generative neural network models based on the comparison result and the analysis result of the emotional state.

12. The system according to claim 11, wherein the circuitry is configured to receive feedback information from the terminal device based on a selection operation by the user with respect to a plurality of presented candidate answer outputs, and to store the feedback information in a storage device together with the emotional state analysis result for use in updating the operation conditions.

13. The system according to claim 12, wherein the circuitry is configured to update the operation conditions by constructing training data pairing the prompt sentence and the feedback information as input-output pairs, and performing parameter adjustment of at least one generative neural network model using an adaptive optimization algorithm.

14. The system according to claim 1, wherein the circuitry is configured to receive attribute information associated with the prompt sentence from the terminal device, classify a type of request represented by the prompt sentence based on the attribute information, and generate a modified prompt sentence specifying processing contents and an output style for the plurality of generative neural network models based on the classified request type and user attributes.

15. The system according to claim 14, wherein the circuitry is configured to store the prompt sentence and the associated attribute information as request information in a storage device, and to retrieve stored request information to augment subsequent prompt sentences during ongoing dialogue with the user.

16. The system according to claim 1, wherein the circuitry is configured to integrate a plurality of candidate answer outputs into integrated answer information when no single candidate answer output satisfies a selection threshold, and to transmit the integrated answer information together with the plurality of candidate answer outputs to the terminal device in a format enabling comparative display.

17. The system according to claim 16, wherein the circuitry is configured to cause the terminal device to present the plurality of candidate answer outputs in a comparable manner and to acquire feedback information based on a selection operation by the user, and to store the feedback information in a storage device for use in updating operation conditions of at least one generative neural network model.

18. A system comprising:
circuitry configured to:
receive, via a communication interface coupled to a packet-switched network, a prompt sentence including an inquiry from a user from a terminal device, and assign the prompt sentence as common input data to a plurality of generative neural network models;
execute parallel operation of the plurality of generative neural network models based on mutually different parameter settings to acquire a plurality of candidate answer outputs;
generate an evaluation prompt sentence encoding each candidate answer output with the original prompt sentence, input the evaluation prompt sentence to at least one generative neural network model, and calculate a comprehensive evaluation score for each candidate answer output based on numerical evaluation values for evaluation indices comprising at least validity, consistency, and clarity;
analyze an emotional state of the user by applying an emotion identification model to user information received from the terminal device, and dynamically adjust weighting coefficients for the evaluation indices based on the analysis result;
select at least one final answer output based on the comprehensive evaluation scores adjusted for the emotional state, generate a transformation prompt sentence for rewriting the final answer output into a style adapted to the emotional state, and input the transformation prompt sentence to at least one generative neural network model to generate emotion-adapted final answer information; and
transmit the emotion-adapted final answer information to the terminal device via the communication interface.

19. The system according to claim 18, wherein the circuitry is configured to receive feedback information from the terminal device based on a user selection operation with respect to presented candidate answer outputs, and to update operation conditions of at least one of the plurality of generative neural network models using training data constructed from the prompt sentence, the feedback information, and the analysis result of the emotional state.

20. A method comprising:
receiving, via a communication interface coupled to a packet-switched network, a prompt sentence including an inquiry from a user from a terminal device, and assigning the prompt sentence as common input data to a plurality of generative neural network models;
executing parallel operation of the plurality of generative neural network models and acquiring a plurality of candidate answer outputs generated respectively by the plurality of generative neural network models based on mutually different parameter settings;
generating an evaluation prompt sentence for each candidate answer output, inputting the evaluation prompt sentence to at least one generative neural network model, and calculating a comprehensive evaluation score for each candidate answer output based on numerical evaluation values for a plurality of evaluation indices;
selecting at least one final answer output from among the candidate answer outputs based on the comprehensive evaluation scores;
analyzing an emotional state of the user based on user information received from the terminal device, and applying an analysis result of the emotional state to at least one of the evaluation prompt sentence or the comprehensive evaluation scores to adjust selection of the final answer output in accordance with the emotional state; and
transmitting the final answer output to the terminal device via the communication interface.
